(19) United States
(12) Patent Application Publication
(10) Pub. No.: US 2024/0336790 A1
(43) Pub. Date: Oct. 10, 2024

(54) PAINT OVERSPRAY TREATMENT COMPOSITIONS AND METHODS OF USE

(71) Applicant: Ecolab USA Inc., St. Paul, MN (US)

(72) Inventors: Petia Todorova Tontcheva, Naperville, IL (US); Rangarani Karnati, Naperville, IL (US); Franklin Defraine Mackin, Shepherdsville, KY (US); Paul Michael Balent, Cincinnati, OH (US); Samuel Pharr Mooney, Birmingham, AL (US); Paul Joseph Zinn, Oswego, IL (US); David Wayne Scheimann, Joliet, IL (US)

(21) Appl. No.: 18/624,204

(22) Filed: Apr. 2, 2024

Related U.S. Application Data
(60) Provisional application No. 63/494,887, filed on Apr. 7, 2023.

(51) Int. Cl. C09D 7/00; C02F 1/52; C02F 103/14; C09D 7/62

(52) U.S. Cl. CPC C09D 7/71; C02F 1/5245; C09D 7/62; C02F 2103/14

(57) ABSTRACT

Overspray treatment compositions for addition to a water source located within a paint overspray waterwash system located in a spray-paint booth, or a water source that is subsequently applied to such a paint overspray waterwash system for contact with a paint overspray include an amine-functionalized colloidal silica having about 0.1 μmol to 15.00 μmol of amine functionality per square meter of silica surface area, and optionally a coagulant. The compositions and methods described herein work within a pH range of 6.5 and 10 to provide treated paint oversprays. Addition of a flocculant to a treated overspray results in formation of associated complexes having low tack, which may be cleanly separated from the aqueous treatment residue. The aqueous treatment residue may be subjected to one or more additional cycles of use in the paint overspray waterwash system.

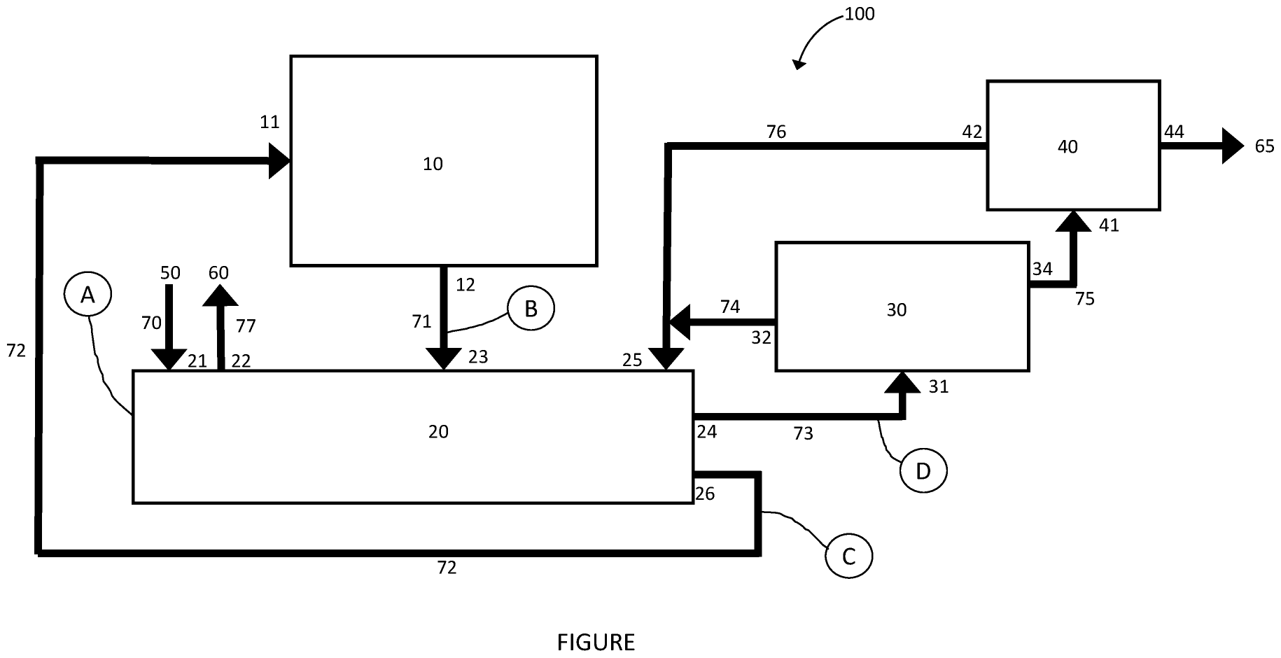

### FIELD OF THE INVENTION

The present invention generally relates to paint overspray waterwash systems and treatment compositions for use therein.

### BACKGROUND

The primary function of a paint booth is to enclose a spray-painting operation within a space that includes a means to separate paint overspray from the air within the booth. By conducting the spraying operation within the booth way, overspray is contained to a small area, and can be efficiently addressed to maintain air quality within a larger facility housing the booth, such as an auto detailing shop or manufacturing facility. Dry filtration methods of forcing air through filtration media similar to conventional dust or furnace filters are effective for removal of paint overspray, but quickly become irreversibly clogged with the tacky paint particles, and cannot be cleaned. These filters thus must be disposed of after a single use, in some cases as flammable waste.

Accordingly, industrial paint booths commonly employ paint overspray waterwash systems to remove airborne paint particulates from the booth interior. Paint overspray waterwash systems employ water as the medium of capturing particulate or aerosol paint overspray, wherein air is directed through a waterwash booth system using either a side-draft or downdraft design. Side-draft booths function by pulling a mixture of paint overspray and air through a mobile water curtain, using the action of the water to “scrub” the paint solids from the water. This water is recirculated from a holding tank and is continuously cascaded down a “waterfall” wall. A downdraft paint booth directs downward airflow, typically through a steel floor grating, into a mobile floodsheet or “horizonal waterfall”. Downdraft systems are commonly employed in large-scale painting operations such as automotive painting, and normally employ much larger volumes of water than side-draft systems.

Paint overspray waterwash water comes into contact with a wide variety of potential pollutants from the paint overspray, making efficacy of treatment difficult to maintain over time as buildup in the water source proceeds. Materials found in paint formulations range from insoluble to partially soluble to completely soluble in water. For example, common paint solvents, which may include xylene, toluene, methylene chloride, and other VOCs, are typically not water soluble but in some cases are partially water miscible or form azeotropes with water. The resins making up the bulk of the solvent-based paint coating are insoluble in water and tend to stay tacky if not treated with some additional material introduced into the water. Other paint additives, such as film-forming/wetting agents, may or may not be soluble in the water and will be present in varying amounts. Pigments and/or inorganic paint components, such as zinc- or chromate-based compounds, may be insoluble, partially soluble, or completely soluble in water. The components of water-based paints are water soluble or highly water dispersible, including the resins, and either dissolve completely, or form extremely fine dispersions or emulsions when diluted by a waterwash waterfall.

If left untreated, these overspray solids build up as a sludge that can plug and/or foul recirculation pipes and pumps, as well as adhere to any and all surfaces of the paint booth, reducing overall efficiency of the paint booth operation and requiring significant down-time for cleaning.

A number of methods have been developed to chemically treat tacky overspray paint sludge collected in paint overspray waterwash systems. These include caustic/hydroxide treatments, metal salt treatment, clay-based treatments, and acid colloid treatments. Caustic/hydroxide treatments and metal salts treatments employ careful pH control for efficacy. Further, caustic/hydroxide treatments are known to be relatively inefficient overall; and metal salts treatments incur dissolution of paint solids, and therefore require an additional treatment step with a polymeric material in order to remove suspended materials and dissolved compounds from the water in order to recycle the water within the waterwash system.

Clay-based treatments act by absorbing water and swelling to form large, irregularly surfaced particulates that adsorb or adhere to the paint particulates entering the waterwash water, and to each other, resulting in a large detackified mass that is easily separated from the water in the waterwash system by common solid-liquid separation techniques. However, the use of swellable clay also leads to large volumes of the detackified mass, and thus large volumes of waste compared with other treatment types. In addition, both water and solvent are often trapped in the clay matrix, making it difficult to landfill and limiting the ability to dewater to an acceptable level, c . . . g. 25% by weight of water or less. Clay materials further tend to develop foaming in the highly agitated waterfall systems, and the waste product is vulnerable to biological contamination due to the entrapment of paint materials with water in the clay sludge.

Acid colloid treatments include silicate amine treatments, silica amine treatments, and melamine-formaldehyde treatments. These materials are applied to a paint overspray waterwash system at alkaline pH to form a complex of the treatment material with one or more paint components present in the water source of the waterwash system.

In a silicate amine treatment, a polyamine and a silicate, such as sodium metasilicate are fed separately to the water present in the waterwash system, with careful control of pH; small differences in pH can cause loss of performance in these systems. Further, silicate amines, fail to disperse paints very well, and they only detackify slowly. Because of this, long run times are required for efficacy, and fouling by unscavenged paint materials may develop in areas of the waterwash system where good mixing does not occur. Silica amine treatment is similar to silicate amine treatment but employs aqueous colloidal silica sol in place of the silicate. For silica amine treatments to be effective, pH is maintained between8.0 and 9.0.

In melamine-formaldehyde treatment, the alternating melamine and formaldehyde in the net-like polymer structure forms a complex with paint particulates under alkaline conditions. However, residual formaldehyde vapor is an issue inherent to these systems that has led to broad abandonment of their use. Further, melamine-formaldehyde systems are highly sensitive to solids loading of the overspray; as loading increases, the level of detackification decreases and the ability to form a tack-free complex is also decreased.

Accordingly, there remains a need in the industry to provide overspray treatment compositions that are capable of effectively detackifying paint overspray at neutral pH. Further, there remains a need in the industry to provide satisfactory detackifying performance with solvent-based paints, and further still satisfactory detackifying performance with both aqueous and solvent-based paints. Further, there remains a need in the industry to provide good separation of paint materials from water over a broad range of compositional dosing, to provide operational flexibility for the overspray treatment and consistently cleaned water after separating. Further, there remains a need in the industry to provide all of the foregoing benefits in a non-hazardous formulation free of VOCs.

### SUMMARY OF THE INVENTION

Described herein are overspray treatment compositions for adding to either a water source located within a paint overspray waterwash system or operably connected to a paint booth overspray waterwash system, or a water source that is subsequently applied to a paint overspray waterwash system. The overspray treatment compositions comprise or consist essentially of a detackifier and optionally a coagulant. The detackifier comprises, consists essentially of, or consists of an amine-functionalized colloidal silica. The amine-functionalized colloidal silica is a silica particulate having a particle size of 1000 nm or less and is surface-functionalized with an aminoalkyltrialkoxysilane. In embodiments the amine-functionalized colloidal silica (also referred to herein as “AFCS”) includes about 0.1 μmol to 15.00 μmol of amine functionality per square meter of silica surface area, for example 0.2 μmol to 10.00 μmol, or 0.3 μmol to 6.00 μmol, or 0.5 μmol to 3.00 μmol of amine functionality per square meter of silica surface area. In embodiments, at least a portion of the amine functionality is covalently bonded to the colloidal silica surface.

In embodiments, an overspray treatment composition further includes water, wherein the overspray treatment composition is an aqueous overspray treatment composition. In embodiments, the aqueous overspray treatment composition is an overspray treatment concentrate including about 5 wt % to about 70 wt % overspray treatment composition solids in water. In other embodiments, the aqueous overspray treatment composition is a treated washwater comprising, consisting essentially of, or consisting of water and about 0.01 ppm to 10,000 ppm overspray treatment composition solids by weight or by weight/volume in water.

In embodiments, an aqueous overspray treatment composition further includes a pH adjustment agent. In other embodiments, an aqueous overspray treatment composition excludes pH adjustment agents. In embodiments, the pH of an aqueous overspray treatment composition is between 2 and 6, or between 7 and 8, or between 6 and 9, or between 9 and 11.

In embodiments, the optional coagulant comprises, consists essentially of, or consists of one or more polyionic compounds, one or more inorganic salts, or a combination of one or more polyionic compounds and one or more inorganic salts. Suitable coagulants include inorganic aluminum, magnesium, or iron salt compounds. In embodiments, the coagulant comprises, consists essentially of, or consists of aluminum sulfate/chloride, ferric chloride/sulfate, polyaluminum chloride, aluminum chloride hydroxide, which is a water-soluble aluminum complex with the general formula AlₙCl₍₃ₙ₋ₘ₎(OH)ₘ; or a combination of two or more of these. In embodiments, the coagulant comprises, consists essentially of, or consists of aluminum chloride hydroxide, Al₂Cl(OH)₅. In embodiments, the coagulant comprises, consists essentially of, or consists of a polyionic compound, such as a polyphosphonium compound, a polysulfonium compound, or a mixture thereof, where a polyionic compound is further defined as a non-polymeric compound having 3 or more ionic moieties bonded thereto. In embodiments, an overspray treatment composition includes a weight ratio of detackifier solids to coagulant solids of about 1:10 to 20:1.

Also disclosed herein are methods of treating a paint overspray present in a paint booth, the methods including combining an overspray treatment composition with a water source to form a treated washwater; adding the treated washwater to an overspray waterwash system located in or fluidly connected to a paint booth; and operating the paint booth and the overspray waterwash system to cause the treated washwater to contact a paint overspray present within the paint booth. In some embodiments the overspray treatment composition and/or the treated washwater are formed using components added and/or used in substantially dry form; in some embodiments both the overspray treatment composition and the treated washwater are aqueous; in still other embodiments a combination of dry and aqueous formats are suitably employed to form and/or deliver the components of the overspray treatment composition and/or the treated washwater to the paint overspray waterwash system or to the water source that is then added to the paint overspray waterwash system. In some embodiments, the method includes adjusting the pH of the water source, the overspray treatment composition, the treated washwater, or two or more thereof to have a pH between 6.5 and 10, or between 6.5 and 8.5, or between 7 and 8. In other embodiments, the method excludes adjusting the pH of the water source, the overspray treatment composition, the treated washwater, or two or more thereof.

In accordance with the foregoing, disclosed herein are treated washwaters comprising, consisting essentially of, or consisting of a mixture of any of the overspray treatment compositions described herein with a water source, wherein the treated washwater is disposed within or located within a paint overspray waterwash system. In embodiments, the pH of a treated washwater is, or is adjusted to be, between 6.5 and 10, or between 6.5 and 8.5, or between 7 and 8. In embodiments, the treated washwaters include about 0.01 ppm to 10,000 ppm by weight or by weight/volume of the amine-functionalized silica. In embodiments, the treated washwaters include about 0.01 ppm to 1000 ppm by weight or by weight/volume of the coagulant. In embodiments, the treated washwaters include about 0.01 ppm to 10,000 ppm by weight or by weight/volume of a combination of the amine-functionalized silica and the coagulant.

Operating the overspray waterwash system employing the foregoing methods causes the treated washwater to contact a paint particulate or aerosol present within a paint booth to form a treated overspray. The treated overspray is characterized as including detackified paint solids. The detackified paint solids are formed by contacting the detackifier and optional coagulant present in the treated washwater with the paint particulates and/or aerosols present in the paint booth during one or more spray painting processes. The contacting is suitably provided using conventional overspray treatment equipment adapted and designed to contact a paint overspray with a washwater, as is familiar to one of ordinary skill in the art of paint overspray waterwash systems.

In embodiments, the methods disclosed herein further include collecting a treated overspray. The treated overspray is suitably collected using conventional collection equipment adapted and designed to receive a paint booth overspray washwater after contacting the washwater with a paint overspray, as is familiar to one of ordinary skill in the art of paint overspray waterwash systems. In embodiments, a collected treated overspray is applied to a tank or other containment adapted and designed to receive and contain a paint booth overspray washwater.

In embodiments, the collected treated overspray includes detackified paint solids. The detackified paint solids comprise or consist essentially of one or more solid paint components combined with one or more AFCS. Optionally, the detackified paint solids further include a coagulant. A detackified paint solid is a discrete aggregated mass including the residues of one or more paint particulates or aerosols, and one or more AFCS; and optionally one or more coagulants. The detackified paint solids described herein are characterized by beneficial properties such as low tack when the detackified paint solids are contacted with finger pressure. In embodiments the detackified paint solids further include or are dispersed in liquid water; in other embodiments the detackified paint solids are separated from the treated overspray and dried to provide a dry detackified paint mass for disposal, further treatment, or some other use. Suitable methods of separating one or more detackified paint solids from a treated overspray include skimming, gravity filtration, suction filtration, cyclonic separation, and settling/decanting, as well as other techniques familiar to those of skill in the art of solid-liquid separations.

In embodiments, the methods disclosed herein further include adding one or more flocculants to a collected treated overspray to provide a flocculated overspray. In such embodiments contacting one or more flocculants with the detackified paint solids present in the collected treated overspray causes the detackified paint solids to associate (or aggregate, or flocculate) to form one or more associated complexes, or “flocs” of detackified paint solids that precipitate from the aqueous phase of the flocculated overspray. Thus, in embodiments a flocculated overspray comprises, consists essentially of, or consists of one or more associated complexes and an aqueous treatment residue. The aqueous treatment residue is the aqueous solution or dispersion portion of the flocculated overspray that remains after the separation of the one or more associated complexes therefrom.

Accordingly, the methods disclosed herein include adding a flocculant to a collected treated overspray to form a flocculated overspray, the flocculated overspray including an amount of an associated complex; and separating at least a portion of the associated complex from the flocculated overspray. Suitable methods of separating include skimming, gravity filtration, suction filtration, cyclonic separation, and settling/decanting, as well as other techniques familiar to those of skill in the art of solid-liquid separations. The separating results in the separation of one or more flocculated complexes from a collected treated overspray, leaving an aqueous treatment residue. In embodiments, two, three or more such separations are carried out serially or in separate processes. Thus, in embodiments a separation is two or more cycles of a single separation process carried out serially; in other embodiments a separation is two or more different processes carried out serially. In embodiments the separating is followed by collecting the flocculated complexes and subjecting the dried flocculated complexes to one or more additional treatments and/or drying and/or disposal.

In embodiments, the ratio of AFCS to flocculant in a flocculated overspray is between 1:10 to 200:1 based on the weight of liquid water. In embodiments, a flocculated overspray includes about 0.01 ppm to 10,000 ppm by weight or by weight/volume of a combination of AFCS and flocculant. In embodiments, a flocculated overspray includes about 0.01 ppm to 10,000 ppm by weight or by weight/volume of a combination of one or more AFCS and one or more flocculants. In embodiments, a flocculated overspray includes about 0.01 ppm to 10,000 ppm by weight or by weight/volume of a combination of one or more AFCS, one or more flocculants, and one or more coagulants.

In accordance with the foregoing, also disclosed herein are associated complexes. The associated complexes are formed within a flocculated overspray. The associated complexes are discrete, aggregated masses comprising or consisting essentially of the residues of one or more paint particulates or aerosols, one or more AFCS, one or more flocculants, and optionally one or more coagulants. Accordingly, also disclosed herein are methods of separating an associated complex from a flocculated overspray to provide an aqueous treatment residue. The methods include solid-liquid separation techniques such as skimming and gravity filtration well as other techniques familiar to those of skill in the art of solid-liquid separations. The methods result in collection of associated complexes and their removal from the flocculated overspray to provide an aqueous treatment residue. The associated complexes are characterized by beneficial properties such as low tack and low smear when contacted with finger pressure, and low adhesion to glass and other surfaces which provides for case of separation of the associated complexes from the collected treated overspray and also provides for less cleaning of the paint overspray waterwash system since the associated complexes do not tend to adhere to the walls of a containment and thus can be cleanly removed. In embodiments the separated associated complexes are dried to provide a dry associated complex mass for disposal, further treatment, or another use.

Also disclosed herein are uses of an overspray treatment composition to form a treated washwater in a paint overspray waterwash system. Also disclosed herein are uses of a treated washwater in a paint overspray waterwash system to form a treated overspray, the treated overspray including detackified paint solids. Also disclosed herein are uses of a treated overspray to form a flocculated overspray, the flocculated overspray including associated complexes. Also disclosed herein are uses of a flocculated overspray to form an aqueous treatment residue having turbidity of less than 800 NTU, or less than 600 NTU, or less than 400 NTU, or less than 200 NTU, for example about 50 NTU to about 150 NTU, or even less than 50 NTU, such as 10 NTU to 50 NTU. Also disclosed herein are uses of an overspray treatment composition and a flocculant in a paint overspray waterwash system to form an aqueous treatment residue having turbidity of less than 800 NTU, or less than 600 NTU, or less than 400 NTU, or less than 200 NTU, for example about 50 NTU to about 150 NTU, or even less than 50 NTU, such as 10 NTU to 50 NTU.

The methods and apparatuses used to contact a paint overspray with a treated washwater may include use of one or more of methods and apparatuses known to those of skill and employing water as the medium of capturing a paint overspray. Accordingly, in embodiments, a first paint overspray-laden air source is directed through a first mobile floodsheet comprising, consisting essentially of, or consisting of a first treated washwater. The first treated washwater contacts the first paint overspray-laden air source, forming a first treated overspray and a first cleaned air source. In embodiments the first treated washwater is located in a continuous flow waterwash booth system, wherein the first treated overspray is collected and one or more flocculants are added to the first collected treated overspray to form a first flocculated overspray, the first flocculated overspray including one or more associated complexes. The associated complexes are separated from the first flocculated overspray using one or more solid-liquid separations.

Accordingly, in a continuous flow waterwash booth system, a first “cycle of use” begins with the formation of a first mobile floodsheet formed from a first treated washwater, and ends with the return of a first aqueous treatment residue thereof to form a second mobile floodsheet formed from a second treated washwater. Thus, in embodiments a second amount of an overspray treatment composition is added to the first aqueous treatment residue to form a second treated washwater; and the second treated washwater is applied to a second cycle of use; and in this manner, up to 1000 cycles of use, or up to 10,000 cycles of use, or even up to 500,000 cycles of use may be obtained before conductivity of a treated washwater reaches a selected limit, such as 40,000 uS/cm, wherein that the paint overspray waterwash system requires complete replacement of the water source and formation of fresh treated washwater. Further, the methods, uses, and compositions disclosed herein are characterized by providing case of separation of associated complexes over each cycle of treated overspray formation, yielding associated complexes characterized as having low tack.

In embodiments, the foregoing uses and methods are carried out during operation of a paint overspray waterwash system, further during a spray-painting operation carried out proximal to the paint overspray waterwash system. In embodiments, a first spray-painting operation is located within a first paint booth, and a paint overspray waterwash system is operable to treat a first paint overspray during a first spray painting operation. In embodiments, a first spray-painting operation and a first paint overspray waterwash system are located within a first paint booth. In other embodiments, a first spray-painting operation is located within a first paint booth, and a first paint overspray waterwash system is fluidly connected to the first paint booth to provide a first mobile floodsheet proximal to a first paint overspray-laden air.

In embodiments, a first paint overspray waterwash system is a multiply-connected paint overspray waterwash system, and is fluidly connected to between 1 and 100 paint booths, that is first to 100^{th} paint booths, and wherein the first paint overspray waterwash system is capable of providing between 1 and 100 mobile floodsheets therein. In embodiments, between 1 and 100 spray-painting operations may be carried out simultaneously within a multiply-connected paint overspray waterwash system. In embodiments, in a multiply-connected paint overspray waterwash system, between 1 and 100 mobile floodsheets are fluidly connected via a manifold to a single source of treated washwater that is applied to 1 to 100 mobile floodsheet forming apparatuses (that is, side-draft or down-draft type apparatuses, or a mixture of these types). In some such embodiments, the 1 to 100 mobile floodsheet forming apparatuses are further fluidly connected to a tank or other apparatus adapted to collect the treated overspray from one or more of the 1 to 100 mobile floodsheets. Flocculant is added to the collected treated overspray from the 1 to 100 mobile floodsheets to form a flocculated overspray, which is separated as discussed above to provide one or more associated complexes and an aqueous treatment residue.

Also disclosed herein are paint overspray treatment kits including one or more components for adding to either a water source located within a paint overspray waterwash system within or fluidly connected to a spray paint booth, or a water source that is subsequently applied to a paint overspray waterwash system within or fluidly connected to a spray paint booth. In embodiments the overspray treatment kits include a first component comprising or consisting essentially of an AFCS (that is, detackifier); a second component comprising, consisting essentially of, or consisting of a flocculant; and optionally a third component comprising, consisting essentially of, or consisting of a coagulant. In embodiments wherein a coagulant is provided in the kit, the ratio of AFCS solids to coagulant solids in the kit is between 1:10 and 20:1 by weight, for example 1:3 to 15:1 by weight. In embodiments, one or more AFCS and one or more coagulants are provided as separate components in a kit. In embodiments one or more AFCS and one or more coagulants are provided as a mixture thereof in a kit. In embodiments, a kit component is an overspray treatment concentrate including about 5 wt % to about 70 wt % overspray treatment composition solids in water.

In embodiments, one or more flocculants are provided as one or more separate components in a paint overspray treatment kit, or are used in connection with the methods described herein, wherein the flocculant is not mixed with an AFCS or an optional coagulant, and is not present as a mixture with an AFCS or with a coagulant. In embodiments, the ratio of AFCS solids to flocculant solids provided in the kit is between 1:10 and 200:1 by weight. In embodiments, one or more AFCS, coagulant, and flocculant are provided in an aqueous solution or dispersion in a kit; in some such embodiments a mixture of the AFCS and the coagulant is provided in an aqueous solution or dispersion. In embodiments, one or more AFCS, coagulant, and flocculant are provided in a concentrate having between 5% and 70% by weight of AFCS solids, coagulant solids, or flocculant solids. In embodiments, one or more coagulants or flocculants are provided in substantially dry form in the kit, that is, as a powder or other form having 20 wt % or less free water.

Other objects and features of the compositions, methods, and uses will be in part apparent and in part pointed out hereinafter.

### BRIEF DESCRIPTION OF THE DRAWINGS

The FIGURE is a schematic representation of a paint overspray waterwash system that may be used in connection with the methods and compositions described herein.

### DETAILED DESCRIPTION

Although the present disclosure provides references to preferred embodiments, persons skilled in the art will recognize that changes may be made in form and detail without departing from the spirit and scope of the invention. Various embodiments will be described in detail. Reference to various embodiments does not limit the scope of the claims attached hereto. Additionally, the Examples set forth in this specification are not intended to be limiting and merely set forth some of the many possible embodiments for the appended claims.

### Definitions

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

As used herein, the term “water source” means pure water, or water having one or more additional chemicals dissolved or dispersed therein. The one or more additional chemicals can include for example: dissolved solids such as those found in tap water or process water located in an industrial facility such as a manufacturing facility; paint particles or one or more paint components; or other compounds determined by context and prior usage and/or treatment of the water source.

As used herein, the term “paint” means a lacquer or a latex including at least a polymer and a solvent, wherein the solvent is water, a mixture of water and one or more water-miscible solvents, a water-immiscible solvent, a mixture of water-immiscible solvents, or a mixture of one or more water-miscible and water-immiscible solvents. In embodiments the paint further includes one or more pigments, dyes, and/or surfactants.

As used herein, the term “paint overspray” refers to the airborne particulates or aerosols that arise as a waste byproduct of any one or more spray-painting processes. The amount of paint overspray as well as particle size and chemical makeup of the overspray depends on numerous variables such as composition and rheological properties of the paint, nozzle design of the spray mechanism and force applied to the paint stream during the spraying, distance between the spray mechanism and the substrate or article to be spray-painted, and other process considerations as determined by the operator of a spray-painting process.

As used herein, the term “paint overspray waterwash system” means any system employing water as the medium of capturing an airborne particulate or aerosol paint, wherein the airborne particulate or aerosol is directed through a waterwash booth system using either a side-draft or downdraft design.

As used herein, the term “proximal” as applied to describe a paint overspray and a treated washwater means that a paint overspray-laden air source is near enough to a mobile floodsheet comprising the treated washwater that the laden air source may be directed to contact the mobile floodsheet to form a cleaned air source and a treated overspray.

As used herein, the term “associated complex” means a physicochemically associated solid mass including one or more paint particles and/or paint particle components and one or more components of an overspray treatment composition. In embodiments, an associated complex is a floc, an agglomerate, a coagulate, or some other structure associated by noncovalent bonds. In embodiments, the associated complex includes an amount of water entrapped, adsorbed, absorbed, or associated therewith; the water may be free water or water chemically associated with one or more components of the associated complex. In embodiments, the associated complex includes between 50 wt % and 80 wt % liquid water, for example after a solid-liquid separation such as skimming or gravity filtration, but before further drying steps are carried out; such an associated complex may be referred to as a “consolidated complex.” In embodiments, a consolidated complex may be dried further to result in a “dewatered complex” having about 20% to 50% liquid water.

As applied to a polymeric or particulate material herein, the term “water soluble”, “aqueous solution” and similar terms refer to the polymer or particulate material dissolved in water or a water source, as determined by context; the polymer or particulate material homogeneously dispersed in water or a water source, as determined by context; or a polymer or particulate material capable of dissolving or homogeneously dispersing at 1 wt % or more in water or a water source, as determined by context, further at a temperature between 17° C. and 27° C.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “substantially” means “consisting essentially of”, and includes “consisting of”. For example, a solution that is “substantially free” of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range, employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, any recited ranges of values contemplate all values within the range and are to be construed as support for claims reciting any sub-ranges having endpoints which are real number values within the recited range. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

### DISCUSSION

Described herein are overspray treatment compositions. The overspray treatment compositions are added to a water source located within a paint overspray waterwash system, or operably connected to a paint booth overspray waterwash system, or the overspray treatment compositions are added to a water source that is subsequently applied to a paint overspray waterwash system. In embodiments, the overspray treatment compositions comprise, consist essentially of, or consist of a detackifier; in some embodiments the overspray treatment compositions comprise, consist essentially of, or consist of a detackifier and a coagulant. The detackifier comprises, consists essentially of, or consists of an amine-functionalized colloidal silica. The amine-functionalized colloidal silica is a silica particulate having a particle size of 1000 nm or less, as determined by either a titrimetric or volumetric technique; and is surface-functionalized with amino groups.

We have found that amine-functionalized colloidal silica, also referred to herein as “AFCS”, are useful as a detackifier in one or more overspray treatment compositions. AFCS is a colloidal silica that is functionalized on the surface thereof with an aminoalkyltrialkoxysilane. Accordingly, suitable detackifiers useful in any one or more of the compositions, methods, and uses described herein comprise or consist essentially of one or more AFCS.

A colloidal silica is a group or collection of submicron size, nonporous silica particles. In embodiments the colloidal silica is dry, and includes less than 10 wt % free water or another liquid; in other embodiments the colloidal silica is suspended or dispersed in a liquid (solvent). A colloidal silica suspended or dispersed in a solvent is referred to as a silica sol. In embodiments the silica sol is dispersed in water, and the silica sol is an aqueous silica sol. In embodiments, a silica sol includes about 5 wt % to 70 wt % silica solids therein, often about 10 wt % to 70 wt % or 20 wt % to 60 wt % silica solids dispersed homogeneously within the solvent.

In embodiments an aqueous silica sol includes silica particles having a particle size, which in some embodiments is a mean particle size, between 1 nm and 1000 nm as determined by acid-base titration or by dynamic light scattering analysis, for example between 1 nm and 500 nm, between 3 nm and 500 nm, between 5 nm and 500 nm, between 10 nm and 500 nm, between 15 nm and 500 nm, between 20 nm and 500 nm, between 25 nm and 500 nm, between 30 nm and 500 nm, between 35 nm and 500 nm, between 40 nm and 500 nm, between 45 nm and 500 nm, between 50 nm and 500 nm, between 60 nm and 500 nm, between 70 nm and 500 nm, between 80 nm and 500 nm, between 90 nm and 500 nm, between 100 nm and 500 nm, between 200 nm and 500 nm, between 300 nm and 500 nm, between 400 nm and 500 nm, between 1 nm and 4 nm, between 4 nm and 10 nm, between 10 nm and 20 nm, between 20 nm and 30 nm, between 40 nm and 50 nm, between 50 nm and 60 nm, between 60 nm and 70 nm, between 70 nm and 80 nm, between 80 nm and 90 nm, between 90 nm and 100 nm, between 100 nm and 200 nm, between 200 nm and 300 nm, between 300 nm and 400 nm, between 400 nm and 500 nm, between 500 nm and 600 nm, between 600 nm and 700 nm, between 700 nm and 800 nm, between 800 nm and 900 nm, or between 900 nm and 1000 nm. In embodiments where the colloidal silica is a fumed silica, the particle sizes recited above are the fumed silica primary particle size. In embodiments where the colloidal silica is an aqueous silica sol, the aqueous silica sol has a pH between about 9 and 10.5. Silica sols are available commercially in a wide variety of particle sizes; and silica sols can also be synthesized using well-established, conventional methodology. A wide range of particle sizes and solids content are available using well-known techniques of aqueous and non-aqueous silica sol synthesis.

Other colloidal silicas that are usefully surface functionalized with an aminoalkyltrialkoxysilane and employed as amine-functionalized colloidal silica in the overspray treatment compositions include fumed silicas. Fumed silica (CAS No. 112945-52-5), also known as pyrogenic silica, is an amorphous silica particulate wherein primary particles are further fused as three-dimensional secondary particles; and the secondary particles may further be agglomerated as tertiary particles. The primary particle size of fumed silica is about 5 nm to 50 nm, providing a surface area of 50 m²/g-600 m²/g. Fumed silica is commercially provided as a dry powder.

A colloidal silica, such as a silica sol or a fumed silica is reacted in aqueous environment with an aminoalkyltrialkoxysilane, or a partially or completely hydrolyzed analog thereof, to produce an amine-functionalized colloidal silica usefully included in the overspray and includes amine groups covalently bonded to the surface thereof.

“Surface functionalization” of a colloidal silica means a functional group is covalently bonded to a chemical moiety on the surface of a colloidal silica particle. Surface functionalization of colloidal silica with alkoxysilyl groups is a well-established reaction that can be carried out using one of a number of known techniques. For example, a targeted amount of aminoalkyltrialkoxysilane may be added directly to an aqueous silica sol, in embodiments further while heating the sol to e.g. 50° C. to 80° C., to obtain reaction of the alkoxysilyl groups with silanol groups present on the surface of the sol particles. Additionally, in some embodiments the pH of the aqueous sol may be adjusted to below 7 in order to obtain effective reaction between the surface of the silica sol particles and the alkoxysilyl groups, such as e.g. methoxysilyl or ethoxysilyl groups present on an aminoalkyltrialkoxysilane. Further, in some embodiments the alkoxysilyl groups are partially hydrolyzed prior to addition thereof to an aqueous silica sol, imparting hydroxyl functionality in order to increase reactivity between the sol surface and the silane, and/or increase solubility of the silane in the aqueous phase. Covalent bonding between an aminoalkyltrialkoxysilane or partially hydrolyzed analog thereof, and the surface of an aqueous silica sol is easily verified using ¹H NMR.

Accordingly, AFCS usefully employed in the compositions, methods, and uses described herein include amine groups covalently bonded to the surface thereof. In some embodiments, the amine groups are primary amine groups. In embodiments, the aminoalkyltrialkoxysilane is 3-aminopropyltrimethoxysilane (APTMS), 3-aminopropyltricthoxysilane (APTES). In other embodiments the amine groups are secondary, tertiary, or quaternary amine or ammonium groups. In embodiments, the amine group of the aminoalkyltrialkoxysilane is-NR¹R²R³, wherein R¹ and R² are independently H or a linear, branched, or cyclic alkyl, alkenyl, alkynyl, aryl, or aralkyl moiety having 1 to 8 carbons; and R³ is optionally present and is H or a linear, branched, or cyclic alkyl, alkenyl, alkynyl, aryl, or aralkyl moiety having 1 to 8 carbons; and where R³ is present, the aminoalkyltrialkoxylsilane is further associated with a counterion such as chloride or hydroxide. In embodiments, the amine group of the aminoalkyltrialkoxysilane is converted to a quaternary amine group after the surface functionalization reaction, that is, after the reaction between the surface of the silica sol particles and the alkoxysilyl groups is completed. In embodiments, the alkyl group of the aminoalkyltrialkoxysilane is a linear, branched, or cyclic alkyl group having 1 to 6 carbons, that is, 1, 2, 3, 4, 5, or 6 carbons. In embodiments, each of the alkoxy groups of the aminoalkyltrialkoxysilane is independently a linear or branched alkoxy group having 1 to 4 carbons, that is, 1, 2, 3, or 4 carbons.

In embodiments the AFCS includes about 0.1 μmol to 15.00 μmol of amine functionality per square meter of silica surface area, for example 0.1 μmol to 14.00 μmol, 0.1 μmol to 13.00 μmol, 0.1 μmol to 12.00 μmol, 0.1 μmol to 11.00 μmol, 0.1 μmol to 10.00 μmol, 0.1 μmol to 9.00 μmol, 0.1 μmol to 8.00 μmol, 0.1 μmol to 7.00 μmol, 0.1 μmol to 6.00 μmol, 0.1 μmol to 5.00 μmol, 0.1 μmol to 4.00 μmol, 0.1 μmol to 3.00 μmol, 0.1 μmol to 2.80 μmol, 0.1 μmol to 2.60 μmol, 0.1 μmol to 2.40 μmol, 0.1 μmol to 2.20 μmol, 0.1 μmol to 2.00 μmol, 0.1 μmol to 1.80 μmol, 0.1 μmol to 1.60 μmol, 0.1 μmol to 1.40 μmol, 0.1 μmol to 1.20 μmol, 0.1 μmol to 1.00 μmol, 0.1 μmol to 0.90 μmol, 0.1 μmol to 0.80 μmol, 0.1 μmol to 0.70 μmol, 0.1 μmol to 0.60 μmol, 0.1 μmol to 0.50 μmol, 0.1 μmol to 0.4 μmol, 0.1 μmol to 0.3 μmol, 0.3 μmol to 15.00 μmol, 0.5 μmol to 15.00 μmol, 0.6 μmol to 15.00 μmol, 0.7 μmol to 15.00 μmol, 0.8 μmol to 15.00 μmol, 0.9 μmol to 15.00 μmol, 1.00 μmol to 15.00 μmol, 1.20 μmol to 15.00 μmol, 1.40 μmol to 15.00 μmol, 1.60 μmol to 15.00 μmol, 1.80 μmol to 15.00 μmol, 2.00 μmol to 15.00 μmol, 2.20 μmol to 15.00 μmol, 2.40 μmol to 15.00 μmol, 2.60 μmol to 15.00 μmol, 2.80 μmol to 15.00 μmol, 3.00 μmol to 15.00 μmol, 4.00 μmol to 15.00 μmol, 5.00 μmol to 15.00 μmol, 6.00 μmol to 15.00 μmol, 7.00 μmol to 15.00 μmol, 8.00 μmol to 15.00 μmol, 9.00 μmol to 15.00 μmol, 10.00 μmol to 15.00 μmol, 11.00 μmol to 15.00 μmol, 12.00 μmol to 15.00 μmol, 13.00 μmol to 15.00 μmol, 14.00 μmol to 15.00 μmol, 0.1 μmol to 0.2 μmol, 0.2 μmol to 0.3 μmol, 0.3 μmol to 0.4 μmol, 0.4 μmol to 0.5 μmol, 0.5 μmol to 0.6 μmol, 0.6 μmol to 0.7 μmol, 0.7 μmol to 0.8 μmol, 0.8 μmol to 0.9 μmol, 0.9 μmol to 1.00 μmol, 1.00 μmol to 1.20 μmol, 1.20 μmol to 1.40 μmol, 1.40 μmol to 1.60 μmol, 1.60 μmol to 1.80 μmol, 1.80 μmol to 2.00 μmol, 2.00 μmol to 2.20 μmol, 2.20 μmol to 2.40 μmol, 2.40 μmol to 2.60 μmol, 2.60 μmol to 2.80 μmol, 2.80 μmol to 3.00 μmol, 3.00 μmol to 4.00 μmol, 4.00 μmol to 5.00 μmol, 5.00 μmol to 6.00 μmol, 6.00 μmol to 7.00 μmol, 7.00 μmol to 8.00 μmol, 8.00 μmol to 9.00 μmol, 9.00 μmol to 10.00 μmol, 10.00 μmol to 11.00 μmol, 11.00 μmol to 12.00 μmol, 12.00 μmol to 13.00 μmol, 13.00 μmol to 14.00 μmol, or 14.00 μmol to 15.00 μmol of amine functionality per square meter of silica surface area.

In embodiments, the amine-functionalized colloidal silica (AFCS) is an aqueous amine-functionalized colloidal silica, that is, an amine-functionalized silica sol. In such embodiments, the pH of the amine-functionalized silica sol is between about 2 and about 11, depending on method of synthesis employed in forming the AFCS and/or the need to achieve a targeted pH for purposes of subsequent use of the AFCS. In embodiments, the AFCS includes about 5 wt % to 70 wt % silica solids therein, often about 10 wt % to 70 wt %, 20 wt % to 60 wt %, 5 wt % to 50 wt %, 5 wt % to 40 wt %, 5 wt % to 30 wt %, 5 wt % to 20 wt %, 5 wt % to 10 wt %, 10 wt % to 15 wt %, 15 wt % to 20 wt %, 20 wt % to 25 wt %, 25 wt % to 30 wt %, 30 wt % to 35 wt %, 35 wt % to 40 wt %, 40 wt % to 45 wt %, 45 wt % to 50 wt %, 50 wt % to 55 wt %, 55 wt % to 60 wt %, 60 wt % to 65 wt %, or 65 wt % to 70 wt % silica solids in an aqueous dispersion.

The amine-functionalized silica sols useful as detackifiers in the methods, compositions, and uses described herein have a particle size between 1 nm and 1000 nm as determined by a dynamic light scattering method, for example between 1 nm and 500 nm, between 3 nm and 500 nm, between 5 nm and 500 nm, between 10 nm and 500 nm, between 15 nm and 500 nm, between 20 nm and 500 nm, between 25 nm and 500 nm, between 30 nm and 500 nm, between 35 nm and 500 nm, between 40 nm and 500 nm, between 45 nm and 500 nm, between 50 nm and 500 nm, between 60 nm and 500 nm, between 70 nm and 500 nm, between 80 nm and 500 nm, between 90 nm and 500 nm, between 100 nm and 500 nm, between 200 nm and 500 nm, between 300 nm and 500 nm, between 400 nm and 500 nm, between 1 nm and 4 nm, between 4 nm and 10 nm, between 10 nm and 20 nm, between 20 nm and 30 nm, between 10 nm and 30 nm, between 40 nm and 50 nm, between 50 nm and 60 nm, between 10 nm and 60 nm, between 5 nm and 60 nm, between 60 nm and 70 nm, between 70 nm and 80 nm, between 80 nm and 90 nm, between 90 nm and 100 nm, between 100 nm and 200 nm, between 200 nm and 300 nm, between 300 nm and 400 nm, between 400 nm and 500 nm, between 500 nm and 600 nm, between 600 nm and 700 nm, between 700 nm and 800 nm, between 800 nm and 900 nm, or between 900 nm and 1000 nm as determined by dynamic light scattering.

In embodiments, the coagulant comprises, consists essentially of, or consists of one or more polyionic compounds, one or more inorganic salts, or a combination of one or more polyionic compounds and one or more inorganic salts. Suitable coagulants include inorganic aluminum, magnesium, or iron salt compounds. In embodiments, the coagulant comprises, consists essentially of, or consists of aluminum sulfate/chloride, magnesium chloride, magnesium oxide, ferric chloride/sulfate, polyaluminum chloride, aluminum chloride hydroxide, which is a water-soluble aluminum complex with the general formula AlₙCl₍₃ₙ₋ₘ₎(OH)ₘ; or a combination of two or more of these. In embodiments, the coagulant comprises, consists essentially of, or consists of aluminum chloride hydroxide, Al₂Cl(OH)₅. In embodiments, the coagulant comprises, consists essentially of, or consists of a polyionic compound, such as a polyphosphonium compound, a polysulfonium compound, or a mixture thereof, where a polyionic compound is further defined as a non-polymeric compound having 3 or more ionic moieties bonded thereto.

In embodiments, the overspray treatment composition includes a weight ratio of AFCS solids to coagulant solids of about 1:10 to 20:1, for example 1:10 to 10:1, or 1:10 to 15:1, or 1:10 to 10:1, or 1:3 to 5:1, or 1:3 to 2:1, or 1:3 to 1:1, or 1:2 to 20:1, or 1:2 to 15:1, or 1:2 to 10:1, or 1:2 to 8:1, or 1:2 to 6:1, or 1:2 to 4:1, or 1:2 to 2:1, or 1:2 to 1:1, or 1:1 to 20:1, or 1:1 to 15:1, or 1:1 to 10:1, or 1:1 to 8:1, or 1:1 to 6:1; or 1:1 to 4:1, or 1:1 to 2:1, or 1:10, or 1:9, or 1:8, or 1:7, or 1:6, or 1:5, or 1:4, or 1:3, or 1:2, or 1:1, or 2:1, or 3:1, or 4:1, or 5:1, or 6:1, or 7:1, or 8:1, or 9:1, or 10:1, or 11:1, or 12:1, or 13:1, or 14:1, or 15:1, or 16:1, or 17:1, or 18:1, or 19:1, or 20:1.

In embodiments, an overspray treatment composition further includes water, wherein the overspray treatment composition is an aqueous overspray treatment composition. In embodiments, the aqueous overspray treatment composition is an overspray treatment concentrate including about 5 wt % to about 70 wt % overspray treatment composition solids in water, for example about 10 wt % to 70 wt %, 20 wt % to 60 wt %, 5 wt % to 50 wt %, 5 wt % to 40 wt %, 5 wt % to 30 wt %, 5 wt % to 20 wt %, 5 wt % to 10 wt %, 10 wt % to 15 wt %, 15 wt % to 20 wt %, 20 wt % to 25 wt %, 25 wt % to 30 wt %, 30 wt % to 35 wt %, 35 wt % to 40 wt %, 40 wt % to 45 wt %, 45 wt % to 50 wt %, 50 wt % to 55 wt %, 55 wt % to 60 wt %, 60 wt % to 65 wt %, or 65 wt % to 70 wt % overspray treatment composition solids in water. In embodiments, an overspray treatment concentrate comprises, consists essentially of, or consists of about 5 wt % to 70 wt % of an AFCS dispersed in water. In embodiments, an overspray treatment concentrate comprises, consists essentially of, or consists of about 5 wt % to 70 wt % of a mixture of one or more AFCS with one or more coagulants, wherein the weight ratio of AFCS solids to coagulant solids in the overspray treatment concentrate is about 1:10 to 10:1, or 1:10 to 15:1, or 1:10 to 10:1, or 1:3 to 5:1, or 1:3 to 2:1, or 1:3 to 1:1, or 1:2 to 20:1, or 1:2 to 15:1, or 1:2 to 10:1, or 1:2 to 8:1, or 1:2 to 6:1, or 1:2 to 4:1, or 1:2 to 2:1, or 1:2 to 1:1, or 1:1 to 20:1, or 1:1 to 15:1, or 1:1 to 10:1, or 1:1 to 8:1, or 1:1 to 6:1; or 1:1 to 4:1, or 1:1 to 2:1, or 1:10, or 1:9, or 1:8, or 1:7, or 1:6, or 1:5, or 1:4, or 1:3, or 1:2, or 1:1, or 2:1, or 3:1, or 4:1, or 5:1, or 6:1, or 7:1, or 8:1, or 9:1, or 10:1, or 11:1, or 12:1, or 13:1, or 14:1, or 15:1, or 16:1, or 17:1, or 18:1, or 19:1, or 20:1. In embodiments, one or more kits described herein include one or more overspray treatment concentrates.

In other embodiments, the aqueous overspray treatment composition is a treated washwater. The treated washwater comprises, consists essentially of, or consists of water and about 0.01 ppm to 10,000 ppm overspray treatment composition solids by weight or by weight/volume (w/v), such as 0.1 ppm to 10,000 ppm, or 1 ppm to 10,000 ppm, or 10 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 1 ppm to 5000 ppm, or 10 ppm to 5000 ppm, or 50 ppm to 5000 ppm, or 100 ppm to 5000 ppm, or 200 ppm to 5000 ppm, or 300 ppm to 5000 ppm, or 400 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.01 to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm by weight or w/v of overspray treatment solids. In embodiments, a treated washwater is disposed within or located within a paint overspray waterwash system, or is prepared and then added to a paint overspray waterwash system. In embodiments, the pH of a treated washwater is, or is adjusted to be between 6.5 and 10.0, or between 6.5 and 9.5, or between 6.5 and 9.0, or between 6.5 and 8.5, or between 7.0 and 10, or between 7.0 and 9.5, or between 7.0 and 9.0, or between 7.0 and 8.5, or between 7.0 and 8.0, or between 6.5 and 7.0, or between 7.0 and 7.5, or between 6.5 and 7.5, or between 7.5 and 8.0, or between 8.0 and 8.5, or between 7.5 and 8.5, or between 8.5 and 9.0, or between 9.0 and 9.5, or between 8.5 and 9.5, or between 9.5 and 10.0, or between 9.0 and 10.0, or between 8.0 and 10.0. In embodiments, the treated washwaters include about 0.01 ppm to 10,000 ppm by weight of one or more AFCS. In embodiments, the treated washwaters include about 0.01 ppm to 1000 ppm of one or more coagulants. In embodiments, the treated washwaters include about 0.01 ppm to 10,000 ppm of a combination of one or more AFCS and one or more coagulants.

In embodiments, the optional coagulant is present in the treated washwater at about 0.01 ppm to 1000 ppm w/v (weight/volume) coagulant solids, for example 0.1 ppm to 1000, ppm, or 1 ppm to 1000 ppm, or 5 ppm to 1000 ppm, or 10 ppm to 1000 ppm, or 20 ppm to 1000 ppm, or 50 ppm to 1000 ppm, or 100 ppm to 1000 ppm, or 150 ppm to 1000 ppm, or 200 ppm to 1000 ppm, or 300 ppm to 1000 ppm, or 400 ppm to 1000 ppm, or 500 ppm to 1000 ppm, or 600 ppm to 1000 ppm, or 700 ppm to 1000 ppm, or 800 ppm to 1000 ppm, or 900 ppm to 1000 ppm, or 0.01 ppm to 0.1 ppm, or 0.1 ppm to 1 ppm, or 1 ppm to 5 ppm, or 5 ppm to 10 ppm, or 10 ppm to 20 ppm, or 20 ppm to 50 ppm, or 50 ppm to 100 ppm, or 100 ppm to 150 ppm, or 150 ppm to 200 ppm, or 200 ppm to 250 ppm, or 250 ppm to 300 ppm, or 300 ppm to 350 ppm, or 350 ppm to 400 ppm, or 400 ppm to 450 ppm, or 450 ppm to 500 ppm, or 500 ppm to 550 ppm, or 550 ppm to 600 ppm, or 600 ppm to 650 ppm, or 650 ppm to 700 ppm, or 700 ppm to 750 ppm, or 750 ppm to 800 ppm, or 800 ppm to 850 ppm, or 850 ppm to 900 ppm, or 900 ppm to 950 ppm, or 250 ppm to 1000 ppm w/v of coagulant solids.

In embodiments, an aqueous overspray treatment composition further includes a pH adjustment agent such as sodium hydroxide or another strong base; hydrochloric acid or another strong acid; or a buffer composition added to achieve a targeted pH. In still other embodiments, the aqueous overspray treatment composition excludes pH adjustment agents. In embodiments, the pH of an aqueous overspray treatment composition is between 2 and 6, or between 7 and 8, or between 6 and 9, or between 9 and 11. In embodiments, the pH of a treated washwater is, or is adjusted to be, between 6.5 and 10, or between 6.5 and 9.5, or between 6.5 and 9, or between 6.5 and 8.5, or between 6.5 and 8, or between 7 and 8. In embodiments, the pH of an overspray treatment concentrate is between 2 and 6, or between 2 and 3, or between 3 and 4, or between 4 and 5, or between 5 and 6.

Also disclosed herein are methods of treating an overspray from a paint booth, including adding the overspray treatment composition to a paint overspray waterwash system located in the paint booth, using any of the methods described above to form a treated washwater; and operating the paint overspray waterwash system while spray painting a paint within the paint booth. In embodiments the overspray treatment composition is formed, added, and/or used in substantially dry form; in other embodiments the overspray treatment composition is formed, added, and/or used as dispersed in water, that is, in aqueous form; in still other embodiments a combination of dry and aqueous formats are suitably employed to form and/or deliver the components of the overspray treatment composition or combinations thereof to a washwater of a paint overspray waterwash system in continuous or batchwise fashion.

The FIGURE shows a schematic representation of an exemplary but nonlimiting paint overspray waterwash system that may be used in connection with the methods and compositions described herein to treat one or more paint oversprays to result in formation of treated oversprays and/or flocculated oversprays. In the FIGURE, arrows represent the direction of aqueous fluid and solid transport, as suitably brought about by one or more pumps, hydrostatic pressure gradients, or other means of causing transport of aqueous fluids (not shown).

Further in the FIGURE, paint overspray waterwash system 100 includes paint spray booth 10, system tank 20, consolidation tank 30, and dewatering apparatus 40. System tank 20 is a containment defining system tank inlets 21, 23, 25 and system tank outlets 22, 24, 26. System tank inlet 21 is fluidly connected to external water source 50 via conduit 70. External water source 50 is a source of water located external to the paint overspray waterwash system, that is, a fresh water, municipal water, tap water, or other water source. Water source 50 is suitably added through inlet 21 to system tank 20. Inlet 23 of system tank 20 is fluidly connected to paint spray booth 10 via conduit 71 at spray booth outlet 12. Inlet 25 of system tank 20 is fluidly connected to dewatering apparatus 40 via conduit 76 at dewatering apparatus outlet 42. Outlet 22 of system tank 20 is fluidly connected via conduit 77 to a wastewater disposal and/or collection area 60 for disposal and/or further treatment of wastewater materials. Outlet 24 of system tank 20 is fluidly connected to consolidation tank 30 via conduit 73 at consolidation tank inlet 31. Outlet 26 of system tank 20 is fluidly connected to paint spray booth 10 via conduit 72 at paint booth inlet 11. Outlet 32 of consolidation tank 30 is fluidly connected to conduit 76 via conduit 74. Outlet 34 of consolidation tank 30 is fluidly connected to dewatering apparatus 40 via conduit 75 at inlet 41 of dewatering apparatus 40. And outlet 44 of dewatering apparatus 40 is connected to a waste disposal and/or collection area 65 for disposal and/or further treatment of dewatered solid waste materials. A, B, C, and D in the FIGURE are to Treatment Inlets A, B, C, and D, respectively, wherein each Treatment Inlet is useful in one or more embodiments herein for applying or adding one or more of an AFCS, a coagulant, and a flocculant to paint overspray waterwash system 100.

In any one or more of the foregoing embodiments, one or more tanks, apparatuses, conduits, fluid connections, inlets, Treatment Inlets, outlets, and the like are suitably formed from or defined by metal materials such as stainless steel or aluminum, and/or one or more of: concrete, carbon fiber composite, silica glass, chemically inert polymer such as HDPE (high density polyethylene), polypropylene or polyvinyl chloride, or an engineering thermoplastic such as ABS, nylon, and the like as well as filled versions of these.

Accordingly, during operation of paint overspray waterwash system 100 of the FIGURE, an overspray treatment composition, such as an overspray treatment concentrate or a treated washwater is suitably added to system tank 20 at Treatment Inlet A. Water from water source 50, which is commonly referred to as a source of “makeup water”, is further added to system tank 20 via inlet 21 as required depending on the configuration of the waterwash system 100 and the specific type of paint process being used. Alternatively, or in addition to adding an overspray treatment composition to system tank 20 via Treatment Inlet A, an overspray treatment composition is suitably added to conduit 71 via an Treatment Inlet B. Alternatively, or in addition to adding an overspray treatment composition to system tank 20 via Treatment Inlet A and/or Treatment Inlet B, an overspray treatment composition is suitably added to conduit 72 via an Treatment Inlet C. Further, individual components of an overspray treatment composition may suitably be added individually at one or more Treatment Inlets of paint overspray waterwash system 100. Further, different concentrations or rates of addition of overspray treatment compositions or overspray treatment composition components may suitably be added individually at one or more Treatment Inlets of paint overspray waterwash system 100. Thus, in accordance with the foregoing discussion, during operation of paint overspray washwater system 100, system tank 20 includes a treated washwater.

In embodiments, the overspray treatment composition is added to system tank 20 or conduit 72 of a paint overspray washwater system 100 in an amount of about 0.01 ppm to 10,000 ppm w/v (weight/volume) to result in the treated washwater. Accordingly, the overspray treatment composition is present in the overspray treatment system, for example in system tank 20 or in conduit 72 in an amount of about 0.01 ppm to 10,000 ppm overspray treatment composition solids, such as 0.1 ppm to 10,000 ppm, or 1 ppm to 10,000 ppm, or 50 ppm to 10,000 ppm, or 100 ppm to 10,000 ppm, or 200 ppm to 10,000 ppm, or 300 ppm to 10,000 ppm, or 400 ppm to 10,000 ppm, or 500 ppm to 10,000 ppm, or 600 ppm to 10,000 ppm, or 700 ppm to 10,000 ppm, or 800 ppm to 10,000 ppm, or 900 ppm to 10,000 ppm, or 1000 ppm to 10,000 ppm, or 1500 ppm to 10,000 ppm, or 2000 ppm to 10,000 ppm, or 3000 ppm to 10,000 ppm, or 4000 ppm to 10,000 ppm, or 5000 ppm to 10,000 ppm, or 6000 ppm to 10,000 ppm, or 7000 ppm to 10,000 ppm, or 8000 ppm to 10,000 ppm, or 9000 ppm to 10,000 ppm, or 0.01 ppm to 5000 ppm, or 0.1 ppm to 5000 ppm, or 1 ppm to 5000 ppm, or 10 ppm to 5000 ppm, or 50 ppm to 5000 ppm, or 100 ppm to 5000 ppm, or 200 ppm to 5000 ppm, or 300 ppm to 5000 ppm, or 400 ppm to 5000 ppm, or 500 ppm to 5000 ppm, or 600 ppm to 5000 ppm, or 700 ppm to 5000 ppm, or 800 ppm to 5000 ppm, or 900 ppm to 5000 ppm, or 1000 ppm to 5000 ppm, or 1500 ppm to 5000 ppm, or 2000 ppm to 5000 ppm, or 3000 ppm to 5000 ppm, or 4000 ppm to 5000 ppm, or 0.01 ppm to 0.1 ppm, or 0.1 ppm to 1 ppm, or 1 ppm to 10 ppm, or 10 ppm to 50 ppm, or 50 ppm to 100 ppm, or 100 ppm to 200 ppm, or 200 ppm to 300 ppm, or 300 ppm to 400 ppm, or 400 ppm to 500 ppm, or 500 ppm to 600 ppm, or 700 ppm to 800 ppm, or 800 ppm to 900 ppm, or 900 ppm to 1000 ppm, or 1000 ppm to 1500 ppm, or 1500 ppm to 2000 ppm, or 2000 ppm to 2500 ppm, or 2500 ppm to 3000 ppm, or 3000 ppm to 3500 ppm, or 3500 ppm to 4000 ppm, or 4000 ppm to 4500 ppm, or 4500 ppm to 5000 ppm, or 5000 ppm to 5500 ppm, or 5500 ppm to 6000 ppm, or 6000 ppm to 6500 ppm, or 6500 ppm to 7000 ppm, or 7000 ppm to 7500 ppm, or 7500 ppm to 8000 ppm, or 8000 ppm to 8500 ppm, or 8500 ppm to 9000 ppm, or 9000 ppm to 9500 ppm, or 9500 ppm to 10,000 ppm w/v of overspray treatment solids.

Further in reference to the FIGURE, during operation of paint overspray waterwash system 100, a treated washwater is applied to paint spray booth 10 at inlet 11 via conduit 72. The treated washwater is contacted with a paint aerosol or airborne particulate inside of paint spray booth 10 to form a treated overspray. Spray booth 10 is adapted and designed to collect the treated overspray and transport the collected treated overspray through outlet 12 and conduit 71, and into system tank 20 via inlet 23. During continuous operation of paint overspray waterwash system 100, the contents of system tank 20 are further transported through outlet 24 and conduit 73 into consolidation tank 30 via inlet 31.

Accordingly, disclosed herein are methods of treating a paint overspray present in a paint booth, the methods including adding an overspray treatment composition as described herein to a water source located in a paint overspray waterwash system to form a treated washwater, or combining an overspray treatment composition with a water source to form a treated washwater; adding the treated washwater to an overspray waterwash system; and operating the overspray waterwash system to cause the treated washwater to contact a paint overspray present within the paint booth. In some embodiments the overspray treatment composition and/or the treated washwater are formed using components added and/or used in substantially dry form; in some embodiments both the overspray treatment composition and the treated washwater are aqueous; in still other embodiments a combination of dry and aqueous formats are suitably employed to form and/or deliver the components of the overspray treatment composition and/or the treated washwater to the paint overspray waterwash system or to the water source that is then added to the paint overspray waterwash system.

The methods and apparatuses used to contact a paint overspray with a treated washwater in accord with the disclosures herein are not particularly limited and may include use of one or more of methods and apparatuses known to those of skill and employing water as the medium of capturing a paint overspray. Accordingly, in embodiments, a first paint overspray-laden air source is directed through a first mobile floodsheet comprising, consisting essentially of, or consisting of a first treated washwater, wherein the first mobile floodsheet is either a side-draft or downdraft type (that is, a horizontal or vertical “waterfall”) that contacts the first paint overspray-laden air source, forming a first treated overspray and a first cleaned air source.

Further in a continuous flow waterwash booth system, the first treated overspray is collected, such as by accumulating in a tank, and one or more flocculants are added to the first collected treated overspray to form a first flocculated overspray, the first flocculated overspray including one or more associated complexes. The associated complexes are separated from the first flocculated overspray using one or more solid-liquid separations such as skimming, gravity filtration, suction filtration, cyclonic separation, settling/decanting, or combinations of two or more thereof to provide a first aqueous treatment residue.

In embodiments of a continuous flow waterwash booth system, a first aqueous treatment residue is used as the water source for forming a second treated washwater, wherein a second amount of an overspray treatment composition is added to the first aqueous treatment residue to form a second treated washwater. Accordingly, in a continuous flow waterwash booth system, a first “cycle of use” begins with the formation of a first mobile floodsheet formed from a first treated washwater, and ends with the return of a first aqueous treatment residue thereof to form a second mobile floodsheet formed from a second treated washwater. The methods, uses, and compositions disclosed herein are characterized by providing case of separation to yield one or more associated complexes characterized as having low tack, and an aqueous treatment residue.

In embodiments, the methods, uses, and compositions disclosed herein provide a paint overspray waterwash system that may reach up to 500,000 cycles of use before conductivity of a treated washwater reaches a selected limit, such as 40,000 μS/cm, wherein that the paint overspray waterwash system requires complete replacement of the water source and formation of fresh treated washwater.

In embodiments, the foregoing uses and methods are carried out during operation of a paint overspray waterwash system, further during a spray-painting operation carried out proximal to the paint overspray waterwash system. In embodiments, a first spray-painting operation is located within a first paint booth, and a paint overspray waterwash system is operable to treat a first paint overspray during a first spray painting operation. In embodiments, a first spray-painting operation and a first paint overspray waterwash system are located within a first paint booth. In other embodiments, a first spray-painting operation is located within a first paint booth, and a first paint overspray waterwash system is fluidly connected to the first paint booth to provide a first mobile floodsheet proximal to a first paint overspray-laden air.

In embodiments, a first paint overspray waterwash system is a multiply-connected paint overspray waterwash system, and is fluidly connected to between 1 and 100 paint booths, that is first to 100th paint booths, and wherein the first paint overspray waterwash system is capable of providing between 1 and 100 mobile floodsheets therein. In embodiments, between 1 and 100 spray-painting operations may be carried out simultaneously within a multiply-connected paint overspray waterwash system. In embodiments, in a multiply-connected paint overspray waterwash system, between 1 and 100 mobile floodsheets are fluidly connected via a manifold to a single source of treated washwater that is applied to 1 to 100 mobile floodsheet forming apparatuses (that is, side-draft or down-draft type apparatuses, or a mixture of these types). In some such embodiments, the 1 to 100 mobile floodsheet forming apparatuses are further fluidly connected to a tank or other apparatus adapted to collect the treated overspray from one or more of the 1 to 100 mobile floodsheets. Flocculant is added to the collected treated overspray from the 1 to 100 mobile floodsheets form a flocculated overspray, which is separated as discussed above to provide one or more associated complexes and an aqueous treatment residue.

In some embodiments, the methods include adjusting the pH of the water source, the overspray treatment composition, the treated washwater, or two or more thereof to have a pH between 6.5 and 10.0, or between 6.5 and 9.5, or between 6.5 and 9.0, or between 6.5 and 8.5, or between 7.0 and 10, or between 7.0 and 9.5, or between 7.0 and 9.0, or between 7.0 and 8.5, or between 7.0 and 8.0, or between 6.5 and 7.0, or between 7.0 and 7.5, or between 6.5 and 7.5, or between 7.5 and 8.0, or between 8.0 and 8.5, or between 7.5 and 8.5, or between 8.5 and 9.0, or between 9.0 and 9.5, or between 8.5 and 9.5, or between 9.5 and 10.0, or between 9.0 and 10.0, or between 8.0 and 10.0 prior to or contemporaneously with contact of a treated washwater with a paint overspray. However, in other embodiments, the pH of the treated washwater is not adjusted, or the pH of an aqueous dispersion of one or more components of the overspray treatment composition is not adjusted, or both of these. Unexpectedly, we have found that the overspray treatment compositions obtain low to no tackiness over a range of pH between about 7 and 9. Additionally, the treated washwaters that include a coagulant that comprises, consists essentially of, or consists of aluminum chloride hydroxide, Al₂Cl(OH)₅ (“ACH”, CAS No. 12042-91-0), contrary to and surprisingly in view of the conventional art and understanding of ordinary skilled artisans that ACH is operational to coagulate paint aerosols only when the ACH is used at pH of 8 to 9.5. The ability to effectively detackify and form detackified paint solids using ACH at neutral pH, such as pH between 7 and 8, provides significant benefits by obviating the need to use strong bases such as NaOH or other hazardous materials.

Operating the overspray waterwash system employing the foregoing methods causes the treated washwater to contact a paint particulate or aerosol present within a paint booth to form a treated overspray. In embodiments, the methods disclosed herein further include collecting a treated overspray. The treated overspray is suitably collected using conventional collection equipment adapted and designed to receive a paint booth overspray washwater after contacting the washwater with a paint overspray, as is familiar to one of ordinary skill in the art of paint overspray waterwash systems. Suitable collection equipment includes but is not limited to equipment for contacting a paint overspray with a washwater, as described above, that is fluidly connected to a tank or other containment designed and adapted to receive and contain a paint booth overspray washwater. In embodiments, a collected treated overspray is applied to a tank or other containment adapted and designed to receive and contain a paint booth overspray washwater.

In embodiments, the methods herein further include adding one or more flocculants to a collected treated overspray to provide a flocculated overspray. In such embodiments contacting one or more flocculants with the detackified paint solids present in the collected treated overspray causes the detackified paint solids to associate (or aggregate, or flocculate) to form one or more associated complexes, or “flocs” of detackified paint solids that precipitate from the aqueous phase of the flocculated overspray. Thus, in embodiments a flocculated overspray comprises, consists essentially of, or consists of one or more associated complexes and an aqueous treatment residue. The aqueous treatment residue is the aqueous solution or dispersion portion of the flocculated overspray that remains after the separation of the one or more associated complexes therefrom.

Accordingly, the methods disclosed herein include adding a flocculant to a collected treated overspray to form a flocculated overspray, the flocculated overspray including an amount of an associated complex; and separating at least a portion of the associated complex from the flocculated overspray. Suitable methods of separating include skimming, gravity filtration such as bag filtration, cyclonic separation (centrifuge or hydrocyclone), and settling/decanting, as well as other techniques familiar to those of skill in the art of solid-liquid separations. The separating results in the separation of one or more flocculated complexes from a collected treated overspray, leaving an aqueous treatment residue.

Referring again to paint overspray waterwash system 100 of the FIGURE, one or more flocculants are added to conduit 73 via Treatment Inlet B and/or D; and the one or more flocculants are contacted with the contents of system tank 20 and/or within consolidation tank 30, forming a flocculated overspray. In embodiments, the one or more flocculants are added consolidation tank 30 or conduit 73 in an amount of about 0.01 ppm to 1000 ppm by w/v (weight/volume) based on the volume of the consolidation tank contents, for example 0.1 ppm to 1000 ppm, or 1 ppm to 1000 ppm, or 5 ppm to 1000 ppm, or 10 ppm to 1000 ppm, or 20 ppm to 1000 ppm, or 50 ppm to 1000 ppm, or 100 ppm to 1000 ppm, or 150 ppm to 1000 ppm, or 200 ppm to 1000 ppm, or 300 ppm to 1000 ppm, or 400 ppm to 1000 ppm, or 500 ppm to 1000 ppm, or 600 ppm to 1000 ppm, or 700 ppm to 1000 ppm, or 800 ppm to 1000 ppm, or 900 ppm to 1000 ppm, or 0.01 ppm to 0.1 ppm, or 0.1 ppm to 1 ppm, or 1 ppm to 5 ppm, or 5 ppm to 10 ppm, or 10 ppm to 20 ppm, or 20 ppm to 50 ppm, or 50 ppm to 100 ppm, or 100 ppm to 150 ppm, or 150 ppm to 200 ppm, or 200 ppm to 250 ppm, or 250 ppm to 300 ppm, or 300 ppm to 350 ppm, or 350 ppm to 400 ppm, or 400 ppm to 450 ppm, or 450 ppm to 500 ppm, or 500 ppm to 550 ppm, or 550 ppm to 600 ppm, or 600 ppm to 650 ppm, or 650 ppm to 700 ppm, or 700 ppm to 750 ppm, or 750 ppm to 800 ppm, or 800 ppm to 850 ppm, or 850 ppm to 900 ppm, or 900 ppm to 950 ppm, or 250 ppm to 1000 ppm w/v of flocculant solids.

In embodiments, flocculants usefully employed in the methods discussed herein comprise, consist essentially of, or consist of a flocculant polymer, which is a water-soluble (or water-dispersible) anionic, cationic, amphoteric, or nonionic polymer having at least 3 repeat units attributable to or derived from the polymerization of one or more monomeric compounds. In embodiments, the flocculant comprises, consists essentially of, or consists of a mixture of two more polymers of varying molecular weight and/o monomer content. Suitable flocculant polymers include, but are not limited to polyacrylamide (homopolymer) and copolymers, terpolymers, or higher interpolymers of 1 mol % to 99 mol % acrylamide with one or more of: acrylic acid or a conjugate base thereof; 2-acrylamido-2-methyl-1-propanesulfonic acid or a conjugate base thereof; methacrylic acid or a conjugate base thereof; dimethylaminoethylacrylate quaternized with a C1-C6 alkyl halide such as methyl chloride, ethyl chloride, n-butyl chloride, or isohexyl chloride; or a C1-C6 alkyl sulfate such as methyl sulfate, ethyl sulfate, n-pentyl sulfate, or n-hexyl sulfate;

dimethylaminoethylmethacrylate quaternized with a C1-C6 alkyl halide or a C1-C6 alkyl sulfate; diallyl dialkyl ammonium halides such as diallyl dimethyl ammonium chloride (DADMAC); methacryloyloxyethyl trimethylammonium methyl sulfate (METAMS), methacrylamido propyl trimethylammonium chloride (MAPTAC), acryloyloxyethyl trimethyl ammonium chloride (AETAC), methacryloyloxyethyl trimethylammonium chloride (METAC). In embodiments suitable flocculant polymers include, but are not limited to homopolymers, copolymers, or higher interpolymers of any of the foregoing monomers, but in particular homopolymers, copolymers, or higher interpolymers of METAMS, MAPTAC, AETAC and/or METAC are useful as flocculant polymers in the overspray treatment compositions.

In embodiments, the flocculant polymer is an interpolymer that includes 1 mol % to 10 mol % acrylamide, or 10 mol % to 20 mol % acrylamide, or 20 mol % to 30 mol % acrylamide, or 30 mol % to 40 mol % acrylamide, or 40 mol % to 50 mol % acrylamide, or 50 mol % to 60 mol % acrylamide, or 60 mol % to 70 mol % acrylamide, or 70 mol % to 80 mol % acrylamide, or 80 mol % to 90 mol % acrylamide, or 90 mol % to 99 mol % acrylamide, or 10 mol % to 30 mol % acrylamide, or 30 mol % to 50 mol % acrylamide, or 40 mol % to 60 mol % acrylamide, or 50 mol % to 70 mol % acrylamide, or 40 mol % to 45 mol % acrylamide, or 45 mol % to 50 mol % acrylamide, or 50 mol % to 55 mol % acrylamide, of 55 mol % to 60 mol % acrylamide, or 60 mol % to 65 mol % acrylamide. In embodiments, the flocculant polymer is a copolymer of acrylamide and one other monomer selected from the list above. In embodiments the acrylamide copolymer flocculant includes 1 mol % to 10 mol % acrylamide, or 10 mol % to 20 mol % acrylamide, or 20 mol % to 30 mol % acrylamide, or 30 mol % to 40 mol % acrylamide, or 40 mol % to 50 mol % acrylamide, or 50 mol % to 60 mol % acrylamide, or 60 mol % to 70 mol % acrylamide, or 70 mol % to 80 mol % acrylamide, or 80 mol % to 90 mol % acrylamide, or 90 mol % to 99 mol % acrylamide, or 10 mol % to 30 mol % acrylamide, or 30 mol % to 50 mol % acrylamide, or 40 mol % to 60 mol % acrylamide, or 50 mol % to 70 mol % acrylamide, or 40 mol % to 45 mol % acrylamide, or 45 mol % to 50 mol % acrylamide, or 50 mol % to 55 mol % acrylamide, of 55 mol % to 60 mol % acrylamide, or 60 mol % to 65 mol % acrylamide; wherein the balance of the copolymer is a cationic monomer, such as any of the cationic monomers listed above. In embodiments, the interpolymer is a copolymer of acrylamide. In embodiments the acrylamide copolymer is a copolymer of acrylamide with a dimethylaminoethylacrylate that is quaternized with a C1-C6 alkyl halide. In some such embodiments the alkyl halide is methyl chloride. In embodiments the acrylamide copolymer is a copolymer of acrylamide with a dimethylaminoethylacrylate that is quaternized with a C1-C6 alkyl sulfate. In some such embodiments the alkyl sulfate is methyl sulfate.

In embodiments, suitable flocculant polymers have a weight average molecular weight of at least about 10,000 g/mol, and often more than 1×10⁶ g/mol. The maximum useful weight average molecular weight of the flocculant polymers is not particularly limited and in embodiments may be as high as 1×10⁸ g/mol or even higher. Accordingly, in embodiments the weight average molecular weight of the flocculant polymers ranges between 10,000 g/mol and 1×10⁸ g/mol, for example between 30,000 g/mol and 1×10⁸ g/mol, or between 50,000 g/mol and 1×10⁸ g/mol, or between 70,000 g/mol and 1×10⁸ g/mol, or between 100,000 g/mol and 1×10⁸ g/mol, or between 300,000 g/mol and 1×10⁸ g/mol, or between 500,000 g/mol and 1×10⁸ g/mol, or between 700,000 g/mol and 1×10⁸ g/mol, or between 1×10⁶ g/mol and 1×10⁸ g/mol, or between 1×10⁷ g/mol and 1×10⁸ g/mol, or between 10,000 g/mol and 500,000 g/mol, or between 500,000 g/mol and 1×10⁶ g/mol, or between 1×10⁶ g/mol and 2×10⁶ g/mol, or between 2×10⁶ g/mol and 3×10⁶ g/mol, or between 3×10⁶ g/mol and 4×10⁶ g/mol, or between 4×10⁶ g/mol and 5×10⁶ g/mol, or between 5×10⁶ g/mol and 6×10⁶ g/mol, or between 6×10⁶ g/mol and 7×10⁶ g/mol, or between 7×10⁶ g/mol and 8×10⁶ g/mol, or between 8×10⁶ g/mol and 9×10⁶ g/mol, or between 9×10⁶ g/mol and 1×10⁷ g/mol, or between 1×10⁷ g/mol and 2×10⁷ g/mol, or between 2×10⁷ g/mol and 3×10⁷ g/mol, or between 3×10⁷ g/mol and 4×10⁷ g/mol, or between 4×10⁷ g/mol and 5×10⁷ g/mol, or between 5×10⁷ g/mol and 6×10⁷ g/mol, or between 6×10⁷ g/mol and 7×10⁷ g/mol, or between 7×10⁷ g/mol and 8×10⁷ g/mol, or between 8×10⁷ g/mol and 9×10⁷ g/mol, or between 9×10⁷ g/mol and 1×10⁸ g/mol, or between 100,000 g/mol and 1×10⁶ g/mol, or between 500,000 g/mol and 1×10⁶ g/mol, or between 1×10⁶ g/mol and 1×10⁷ g/mol.

In embodiments the flocculant comprises, consists essentially of, or consists of a combination of two or more of any of the foregoing polymers. In some embodiments, a flocculant comprises, consists essentially of, or consists of two or more cationic flocculant polymers; or of one or more cationic flocculant polymer with one or more anionic flocculant polymer; or a of two or more anionic flocculant polymers. In some such embodiments, a ratio of anionic and cationic flocculant polymers may be added to a treated overspray to obtain a targeted ionic balance of the flocculant polymer mixture.

In embodiments, a flocculated overspray includes a weight ratio of AFCS solids to flocculant solids of about 1:10 to 200:1, for example 1:10 to 150:1, or 1:10 to 100:1, or 1:1 to 200:1, or 1:1 to 150:1, or 1:1 to 100:1, or 1:1 to 20:1, or 1:3 to 20:1, or 1:3 to 18:1, or 1:3 to 16:1, or 1:3 to 14:1, or 1:3 to 12:1, or 1:3 to 10:1, or 1:3 to 8:1, or 1:3 to 6:1, or 1:3 to 4:1, or 1:3 to 2:1, or 1:3 to 1:1, or 1:2 to 18:1, or 1:2 to 16:1, or 1:2 to 14:1, or 1:2 to 12:1, or 1:2 to 10:1, or 1:2 to 8:1, or 1:2 to 6:1, or 1:2 to 4:1, or 1:2 to 2:1, or 1:2 to 1:1, or 1:1 to 20:1, or 2:1 to 20:1, or 3:1 to 20:1, or 4:1 to 20:1, or 5:1 to 20:1, or 6:1 to 20:1, or 7:1 to 20:1, or 8:1 to 20:1, or 9:1 to 20:1, or 10:1 to 20:1, or 11:1 to 20:1, or 12:1 to 20:1, or 13:1 to 20:1, or 14:1 to 20:1, or 15:1 to 20:1, or 16:1 to 20:1, or 17:1 to 20:1, or 18:1 to 20:1, or 19:1 to 20:1, or 1:2 to 1:1, or 1:1 to 2:1, or 2:1 to 3:1, or 3:1 to 4:1, or 4:1 to 5:1, or 5:1 to 6:1, or 6:1 to 7:1, or 7:1 to 8:1, or 8:1 to 9:1, or 9:1 to 10:1, or 10:1 to 11:1, or 11:1 to 12:1, or 12:1 to 13:1, or 13:1 to 14:1, or 14:1 to 15:1, or 15:1 to 16:1, or 16:1 to 17:1, or 17:1 to 18:1, or 18:1 to 19:1, or 1:2, or 1:1, or 2:1, or 3:1, or 4:1, or 5:1, or 6:1, or 7:1, or 8:1, or 9:1, or 10:1, or 11:1, or 12:1, or 13:1, or 14:1, or 15:1, or 16:1, or 17:1, or 18:1, or 19:1, or 20:1, or 30:1, or 40:1, or 50:1, or 60:1, or 70:1, or 80:1, or 90:1, or 100:1, or 150:1, or 200:1.

In embodiments, contacting one or more flocculants with the detackified paint solids present in the collected treated overspray causes the detackified paint solids to associate (or aggregate, or flocculate) to form one or more associated complexes, or “flocs” of detackified paint solids that precipitate from the aqueous phase of the flocculated overspray. Thus, in embodiments a flocculated overspray comprises, consists essentially of, or consists of one or more associated complexes and an aqueous treatment residue. Accordingly, the methods disclosed herein include adding a flocculant to a collected treated overspray to form a flocculated overspray, the flocculated overspray including an amount of an associated complex; and separating at least a portion of the associated complex from the flocculated overspray.

Referring to paint overspray waterwash system 100 of the FIGURE, upon addition of flocculant at Treatment Inlet B and/or D to a collected treated overspray present within conduit 73, a flocculated overspray is formed. Consolidation tank 30 provides for physical separation of a flocculated overspray into one or more associated complexes and an aqueous treatment residue. Suitable methods of separating include skimming, and gravity filtration such as sedimentation, suction filtration, cyclonic separation (centrifuge or hydrocyclone), and settling/decanting, as well as other techniques familiar to those of skill in the art of solid-liquid separations. In paint overspray waterwash system 100, the aqueous treatment residue is transported from consolidation tank 30 through outlet 32 to conduit 76 via conduit 74, and returned to system tank 20 through conduit 76 and inlet 25; and the associated complexes are transported to through outlet 34 of consolidation tank 30 and conduit 75 to inlet 41 of dewatering apparatus 40.

The associated complexes are discrete, aggregated masses comprising or consisting essentially of the residues of one or more paint particulates or aerosols, one or more AFCS, one or more flocculants, and optionally one or more coagulants. The associated complexes are characterized by beneficial properties such as low tack and low smear when contacted with finger pressure, and low adhesion to glass and other surfaces which provides for case of separation of the associated complexes from the flocculated overspray and also provides for less cleaning of a paint overspray waterwash system since the associated complexes do not tend to adhere to the walls of a containment, such as the walls of consolidation tank 30 or conduit 73 in paint overspray waterwash system 100 of the FIGURE; and thus do not tend to cause fouling of an paint overspray waterwash system, such as paint overspray waterwash system 100. Further, the associated complexes float on surface of the flocculated overspray in compacted form, that is, the associated complexes do not tend to disperse, which further provides case of collection of the separated associated complexes.

Further, due to the clean partitioning of the associated complexes from the flocculated overspray that arises inherently due to the use of any of the overspray treatment compositions as described herein, an aqueous treatment residue remaining after the physical separation thereof from the one or more associated complexes, such as by skimming, gravity filtration, sedimentation, suction filtration, cyclonic separation, settling/decanting, and the like is characterized as having turbidity of 800 NTU (turbidity units) or less, for example 2 NTU to 600 NTU, or 5 NTU to 600 NTU, or 10 NTU to 400 NTU, or 20 NTU to 200 NTU, or 30 NTU to 200 NTU, or 40 NTU to 200 NTU, or 50 NTU to 200 NTU, or 60 NTU to 200 NTU, or 70 NTU to 200 NTU, or 80 NTU to 200 NTU, or 90 NTU to 200 NTU, or 100 NTU to 200 NTU, or 110 NTU to 200 NTU, or 120 NTU to 200 NTU, or 130 NTU to 200 NTU, or 140 NTU to 200 NTU, or 150 NTU to 200 NTU, or 160 NTU to 200 NTU, or 170 NTU to 200 NTU, or 180 NTU to 200 NTU, or 190 NTU to 200 NTU, or 2 NTU to 4 NTU, or 4 NTU to 6 NTU, or 6 NTU to 8 NTU, or 8 NTU to 10 NTU, or 10 NTU to 20 NTU, or 20 NTU to 30 NTU, or 30 NTU to 40 NTU, or 40 NTU to 50 NTU, or 50 NTU to 60 NTU, or 60 NTU to 70 NTU, or 70 NTU to 80 NTU, or 80 NTU to 90 NTU, or 90 NTU to 100 NTU, or 100 NTU to 110 NTU, or 110 NTU to 120 NTU, or 120 NTU to 130 NTU, or 130 NTU to 140 NTU, or 140 NTU to 150 NTU, or 150 NTU to 160 NTU, or 160 NTU to 170 NTU, or 170 NTU to 180 NTU, or 180 NTU to 190 NTU, or 190 NTU to 200 NTU.

As noted above in reference to paint overspray waterwash system 100 of the FIGURE, one or more associated complexes are separated from a flocculated overspray present in consolidation tank 30 and the separated associated complexes are transported through outlet 34 of consolidation tank 30 and conduit 75 to inlet 41 of dewatering apparatus 40. The separated associated complexes are dried within dewatering apparatus 40 to provide a dried associated complex mass. Drying in this context means to reduce the amount of aqueous treatment residue associated with the associated complex, such as by suction filtration, application of heat and/or air flow, combinations of these, or another technique familiar to those of ordinary skill to reduce the amount of free water associated with a solid mass. Accordingly, the dried associated complex is transported from dewatering apparatus 40 through outlet 44 to waste disposal and/or collection area 65 for disposal, further treatment, or another use; and the additional aqueous treatment residue obtained from the drying is transported from dewatering apparatus 40 through outlet 42 to conduit 76, and returned to system tank 20 through conduit 76 and inlet 25; the additional aqueous treatment residue may be further combined with the aqueous treatment residue applied from conduit 74 to conduit 76 as noted above.

An aqueous treatment residue in accordance with any of the methods and compositions described herein is suitably recycled within a paint overspray waterwash system, or discarded, or further passed from a paint overspray waterwash system and applied to another use. In embodiments, recycling is accomplished by employing a continuous cycling system such as the paint overspray waterwash system 100 of the FIGURE, where treated overspray is applied to system tank 20 via conduit 71 and aqueous treatment residues are suitably returned to system tank 20 via conduit 76, and additional overspray treatment composition is added to form a treated washwater in paint spray booth 10, while contemporaneous removal of the contents system tank 20 via conduit 73 subjects the contents of system tank 20 to flocculation and separation of flocculated overspray.

Discarding of an aqueous treatment residue as a wastewater in a continuously operating paint overspray waterwash system, such as paint overspray waterwash system 100 of the FIGURE is suitably provided by removal of a portion of the contents of the system tank 20 and provision of external water to system tank 20 to replace the volume of tank contents removed. Accordingly, outlet 22 of system tank 20 is fluidly connected via conduit 77 to a wastewater disposal and/or collection area 60 for disposal and/or further treatment of the contents of system tank 20 removed as wastewater. During operation of paint overspray waterwash system 100, a portion of the contents of system tank 20 are transported through outlet 22 and conduit 77 to a wastewater disposal and/or collection area 60 for disposal and/or further treatment in accordance with wastewater treatment methods familiar to one of ordinary skill in methods of treating aqueous industrial wastewaters. Additionally during operation of paint overspray waterwash system 100, replacement water is added to system tank 20 from external water source 50 through conduit 70 an inlet 21 to replenish the volume of the contents of system tank 20.

In embodiments that accord with the compositions, methods, and uses herein, further described herein are overspray treatment kits. In embodiments, an overspray treatment kits comprises, consists essentially of, or consists of an overspray treatment composition for addition by a user to either a water source located within a paint overspray waterwash system, or a water source that is subsequently applied to a paint overspray waterwash system.

In embodiments an overspray treatment kit includes a first component comprising or consisting essentially of an AFCS (that is, detackifier); a second component comprising, consisting essentially of, or consisting of a flocculant; and optionally a third component comprising, consisting essentially of, or consisting of a coagulant. In embodiments where a coagulant is provided in a kit, the ratio of AFCS solids to coagulant solids in the kit is between 1:10 and 20:1 by weight. In embodiments, one or more AFCS and one or more coagulants are provided as separate components in a kit. In embodiments one or more AFCS and one or more coagulants are provided as a mixture thereof in a kit.

In embodiments, a kit includes one or more flocculants provided as one or more separate components therein, wherein the flocculant is not present as a mixture with an AFCS or with a coagulant in a kit. In embodiments, the ratio of AFCS solids to flocculant solids provided in a kit is between 1:10 and 200:1 by weight. In embodiments, one or more AFCS, coagulant, and flocculant are provided in a kit as aqueous solutions or dispersions; in some such embodiments a mixture of the AFCS and the coagulant is provided in an aqueous solution or dispersion. In embodiments a kit includes an overspray treatment concentrate including about 5 wt % to about 70 wt % overspray treatment composition solids in water. In embodiments a kit includes a flocculant component including about 5 wt % to about 70 wt % flocculant solids in water. In some embodiments, one or more coagulants and/or one or more flocculants are provided in substantially dry form in the kit, that is, as a powder or other form having 20 wt % or less free water.

In embodiments, overspray treatment kits include a detackifier comprising, consisting essentially of, or consisting of an amine-functionalized colloidal silica; optionally a coagulant selected from one or more polyionic compounds, one or more inorganic salts, or a combination of one or more polyionic compounds and one or more inorganic salts; a flocculant comprising, consisting essentially of, or consisting of a water-soluble polymer; and instructions that direct the user to obtain a treated washwater having 0.01 ppm to 10,000 ppm of an overspray treatment composition in a water source. In some embodiments the instructions may further instruct a user to adjust the pH of a treated washwater to be between 6.5 and 10.0, or between 6.5 and 9.5, or between 6.5 and 9.0, or between 6.5 and 8.5, or between 7.0 and 10, or between 7.0 and 9.5, or between 7.0 and 9.0, or between 7.0 and 8.5, or between 7.0 and 8.0, or between 6.5 and 7.0, or between 7.0 and 7.5, or between 6.5 and 7.5, or between 7.5 and 8.0, or between 8.0 and 8.5, or between 7.5 and 8.5, or between 8.5 and 9.0, or between 9.0 and 9.5, or between 8.5 and 9.5, or between 9.5 and 10.0, or between 9.0 and 10.0, or between 8.0 and 10.0. In other embodiments the instructions advise a user that no pH adjustment of a treated washwater is required.

In embodiments, the kit includes instructions for the user to add 0.01 ppm to 10,000 ppm by weight of one or more AFCS, as solids, based on the volume of a water source located within a paint overspray waterwash system, or a water source that is subsequently applied to a paint overspray waterwash system. In embodiments, the kit includes instructions for the user to add about 0.01 ppm to 1000 ppm by weight of the coagulant, as solids, to either a water source located within a paint overspray waterwash system, or a water source that is subsequently applied to a paint overspray waterwash system. In embodiments, the kit includes instructions for the user to add about 0.01 ppm to 1000 ppm by weight of the flocculant, as solids, to a volume of treated overspray.

The compositions, methods, uses, and kits described herein are surprisingly effective over the results obtained by previously known compositions, methods, and uses for treating overspray from a paint booth, because treated washwaters including the overspray treatment composition are operable at neutral pH to form associated complexes with one or more paint particulates that enter the treated washwater of a paint overspray waterwash system, and further operate to do so efficiently across the range of pH between 6.5 and 10. Further, due to the tendency of the associated complexes to form compacted detackified masses that float on surface of the treated water source, the associated complexes are easily and cleanly separated from the water in the paint overspray waterwash system to provide a an aqueous residue having turbidity of 800 NTU or less; or having turbidity of 200 NTU or less after 1 cycle of use; or both of these.

### EXPERIMENTAL

### Paint Detackification Test Procedure

A clean 16 oz (473 mL) glass jar is charged with 200 ml of clarified paint booth water or tap water, and 0.1 to 0.6 mL of a detackifier that is either an amine modified silica or a suitable control material, is added to the jar; optionally, a coagulant is also added to the jar. If pH is adjusted, a buffer solution or a dilute sodium hydroxide solution is added to the jar to provide the targeted pH; the pH is adjusted before or after addition of the detackifier. The jar is tightly capped and swirled vigorously; during the swirling, about 0.3 mL to 0.5 mL of a paint material is added dropwise to the jar. Then the jar is capped and swirled vigorously for an additional 10-30 seconds. Then 0.5 mL to 1.0 mL of a 1 wt % solution of cationic acrylamide copolymer, Core Shell 71306 (obtained from the Nalco Water company of Naperville, Illiniois), referred to as the “flocculant” below, is added to the jar and the jar is gently swirled for 15 seconds to thoroughly mix all components.

Then the contents of the jar are poured into a 16 oz. (473 mL) clear disposable plastic cup, and observations regarding sludge tackiness, “sludge quality”, and turbidity of the supernatant liquid in the cup are recorded. “Poor” sludge quality means small or small to medium clumps of solids are floating on the surface that appear partly dispersed, and settled solids are clearly visible at bottom of jar; “Good” sludge quality means most of the solids in the jar are floating on surface in medium to large clumps that are compact, with very little or some evidence of dispersion; and very little or some visible settled solids at the bottom of the jar; and “Excellent” sludge quality means large clumps of solids are floating on surface of water that are highly compact with no evidence of dispersion; and no settled solids are visible at bottom of jar.

Additionally, turbidity of the supernatant water phase may be measured using a nephelometer (turbidity meter) where turbidity is reported in nephelometric turbidity units (NTU). Further, turbidity rating of “Excellent” means turbidity of 20 NTU or less, further wherein the visual appearance of the supernatant water phase may be substantially clear, with very little to no cloudiness visible and very little to no solids visibly dispersed therein; turbidity rating of “Good” means turbidity between about 20 and 50 NTU, further wherein some solids and/or cloudy appearance of the supernatant water phase is apparent; and turbidity rating of “Poor” means turbidity of 50 NTU or more, further wherein the visual appearance of the supernatant water phase may be very cloudy, and/or large amounts of solids are visibly dispersed therein.

If any masses of solid are observed in the jar, a small amount of the mass is removed from the jar and rubbed between clean, wetted fingers in order to provide observations regarding “tackiness” of the mass. A completely detackified mass is not sticky when rubbed between wetted fingers and leaves no visible smeared paint on the fingers.

### Example 1

Aqueous silica sols were obtained from Nalco Water of Naperville, IL. Table 1 shows the surface area and particle size of the silica sols, where particle size is listed as reported by the manufacturer or measured by dynamic light scattering. All the sols were found to have a pH between 9 and 10.5 as received. The amount of hydrolyzed APTES added per m² of sol particle surface area is noted in Table 1. Percent solids and pH of the resulting amine-functionalized colloidal silica (AFCS Sample) is also shown in Table 1.

For each of AFCS shown in Table 1, the following synthetic procedure was used. A 3-neck, 1-L reactor was fitted with a) an overhead mechanical stirrer connected to a metal/glass shaft with Teflon blade and/or a conical stirrer b) feedline for silane addition via syringe pump and c) temperature probe. The reactor was charged with deionized water and nitric acid and mixed for 15-30 min to obtain pH of 1.0-2.0. Then an aqueous colloidal silica was added to reactor in an amount to obtain a concentration of 16-17% (w/v) silica nanoparticles; and the contents of the reactor were heated to 70° C. Then a hydrolyzed aminopropyl triethoxysilane (APTES) solution was added to the contents of the reactor over 45 minutes while the reactor contents were stirred at 70° C. The pH of the reactor contents was maintained at less than 3.0 while the reactor contents were stirred at 70° C. for 4 hours. Finally, the contents of the reactor were cooled to ambient temperature (generally 17° C.-23° C.) and pH of the cooled reactor contents adjusted to less than 3.0 using nitric acid. A small aliquot of the reactor contents was analyzed by 1H NMR to determine the amount of silane associated with or bound to silica.

TABLE 1
Surface area and particle size of silica sols used to synthesize
amine-functionalized colloidal silica (AFCS); μmol APTES
per square meter of silica surface area employed in the
Synthetic Procedure; and wt % solids and pH of AFCS-1
to -5 of Example 1. Ranges of particle size indicate batch-
to-batch variations reported by the manufacturer.

| AFCS | Surface | Particle | μmol APTES/m² | Wt. % | |
|---|---|---|---|---|---|
| Sample | area (m²/g) | size, nm | Surface Area | solids | pH |
| AFCS-1 | 80 | 40-50 | 2.50 | 22.7 | 2.4 |
| AFCS-2 | 250 | 12-13 | 0.75 | 18.3 | 2.2 |
| AFCS-3 | 200 | 15 | 1.10 | 17.8 | 2.5 |
| AFCS-4 | 130 | 23 | 0.90 | 23.1 | 2.6 |
| AFCS-5 | 85 | 20-30 | 0.75 | 26.5 | 2.4 |

### Example 2

AFCS-2 was subjected to the Paint Detackification Test Procedure, except that only 300 mL of tap water was used in the test. In the test, two different solvent-based commercial paint samples were reduced to spray: Paint Code 8110-1, a one-component dark gray primer obtained from the National Paint Alliance of Lansing, Michigan (“1K Solvent Prime”) and Paint Code JCCT6510BK, a two-part clearcoat hardener obtained from PPG Industries, Inc. of Grand Haven, Michigan (“2K Solvent Clearcoat”), as shown in Table 2. In each test, 0.5 mL of a paint was added to the test jar along with AFCS-2.

Additionally, a flocculant (Core Shell 71306, a cationic acrylamide copolymer obtained from the Nalco Water company of Naperville, Illiniois) was added to the to the test jars in the amounts indicated in Table 2.

In each of the tests of Table 2, a precipitate was observed to form. The tackiness of the precipitate was assessed. Additionally, sludge quality was observed and turbidity of the supernatant was measured in each test. Observations of sludge quality, turbidity of the supernatant, and tackiness of sludge masses are shown in Table 2.

TABLE 2
Materials and amounts used in the Paint Detackification
Test of Example 2, and observed test results of
tackiness, sludge quality, and turbidity.

| | Floccu- | | | | | |
|---|---|---|---|---|---|---|
| Material, | lent, | | | | | |
| ppm | ppm | Paint | | Tacki- | Sludge | |
| solids | solids | Type | pH | ness | Quality | Turbidity |
| AFCS-2, | 7.0 | 1K | 7.8 | None to | Excellent | Excellent |
| 334 | | Solvent | | Light | | |
| | | Prime | | | | |
| AFCS-2, | 7.0 | 2K | 7.8 | None to | Excellent | Good |
| 400 | | Solvent | | Light | | |
| | | Clearcoat | | | | |
| AFCS-2, | 13.9 | 1K | 7.8 | None to | Excellent | Good |
| 400 | | Solvent | | Light | | |
| | | Clearcoat | | | | |

### Example 3

The procedure of Example 2 was repeated with AFCS-5, and only the 2K Solvent Clearcoat was tested. In each test, 0.3 mL of 2K Solvent Clearcoat was added to the test jar. The pH of the water was not adjusted, and the pH of the combined contents of the jar was between 7 and 8 and was not further adjusted. In each of the tests of Table 3, a precipitate was observed to form. Observations of sludge quality, and tackiness of sludge masses are shown in Table 3. Further, turbidity of the supernatant liquids was measured and the results are also shown in Table 3. AFCS-5 was shown to perform well at wide dose operating ranges.

TABLE 3
Amounts of AFCS-5 and flocculant, and pH in the Paint Detackification
Test of Example 3, and observed test results of sludge quality,
turbidity of the supernatant, and tackiness of sludge masses.

| AFCS-5, | Flocculant, | | | Sludge | Turbidity, |
|---|---|---|---|---|---|
| ppm solids | ppm solids | pH | Tackiness | Quality | NTU |
| 580 | 8.4 | 7.5 | None | Good | 6.1 |
| 868 | 12.5 | 7.5 | None | Good | 11.1 |
| 1155 | 16.6 | 7.5 | None | Good | 13.8 |

### Example 4

The procedure of Example 2 was repeated using AFCS-2 combined with ACH as a coagulant, further as shown in Table 4. Water was added to the test jar, then the AFCS-2 and ACH were each added separately to the test jar; then the flocculant was added to the test jar; then 0.3 mL of paint was added to the test jar. The pH of the water was adjusted where noted in Table 4; otherwise, the pH of the combined contents of the jar was measured and noted in Table 4 but was not further adjusted. The weight ratio of AFCS-2 solids to coagulant solids in the jar was varied between 2:1 and 1.3:1. In each of the tests of Table 4, a precipitate was observed to form. Observations of sludge quality, turbidity of the supernatant, and tackiness of sludge masses are shown in Table 4.

TABLE 4
Amount of AFCS-2 and flocculant, paint type, and pH employed in the Paint
Detackification Test of Example 4, and observed test results of sludge
quality, turbidity of the supernatant, and tackiness of sludge masses.

| AFCS-2, | ACH, | Flocculant, | | | | | |
|---|---|---|---|---|---|---|---|
| ppm | ppm | ppm | Paint | | | Sludge | |
| solids | solids | solids | Type | pH | Tackiness | Quality | Turbidity |
| 300 | 149 | 10.4 | 2K | 7.1 | None | Excellent | Good |
| | | | Solvent | | | | |
| | | | Clearcoat | | | | |
| 300 | 149 | 10.4 | 2K | 8.1* | None to | Poor to | Good |
| | | | Solvent | | Light | Good | |
| | | | Clearcoat | | | | |
| 200 | 149 | 8.4 | 1K | 7.2 | None to | Good | Good |
| | | | Solvent | | Light | | |
| | | | Prime | | | | |
| 200 | 149 | 6.3 | 1K | 8.7* | None to | Good | Good |
| | | | Solvent | | Light | | |
| | | | Prime | | | | |

*pH of the water added to the test jar was adjusted prior to addition of other components to the test jar.

The combination of amine-functionalized colloidal silica with aluminum chloride hydroxide worked well to remove the paint tackiness for the two solvent-based paints pH between 7.1 and 8.7, further over a range of amounts and ratios of the two materials.

### Example 5

The procedure of Example 2 was repeated using AFCS-2 and ACH, further as shown in Table 5. First, AFCS-2 and ACH were mixed, and the mixture was added to the test jar; then the flocculant was added to the test jar; then 0.3 mL of the paint was added to the test jar. The total amount of AFCS-2 and ACH added to the test jar is shown in Table 5. In each of the tests of Table 5, a precipitate was observed to form. Observations of sludge quality, turbidity of the supernatant, and tackiness of sludge masses are also shown in Table 5. The combination of amine-functionalized colloidal silica with aluminum chloride hydroxide worked well to remove the paint tackiness for the two solvent-based paints at pH between 7.1 and 8.7, and in particular where pH of the water used in the test was not adjusted prior to testing; and additionally over a range of concentrations and at different ratios of the AFCS and flocculant materials in the water.

TABLE 5
Ratio and total amount of AFCS-2 and ACH, flocculant amount, paint type, and pH employed
in the Paint Detackification Test of Example 5, and observed test results of sludge
quality, turbidity of the supernatant, and tackiness of sludge masses.

| | | | Total | | | | |
|---|---|---|---|---|---|---|---|
| AFCS-2:ACH | | | [AFCS-2 + | Flocculant, | | | |
| Solids | Paint | | ACH], ppm | ppm | | Sludge | |
| Ratio | Type | pH | solids | solids | Tackiness | Quality | Turbidity |
| 0.37:1 | 2K | 8.3 | 389 | 10.4 | None to | Good | Good |
| | Solvent | | | | Light | | |
| | Clearcoat | | | | | | |
| 0.37:1 | 2K | 7.8 | 389 | 12.5 | Light | Poor to | Good |
| | Solvent | | | | | Good | |
| | Clearcoat | | | | | | |
| 0.37:1 | 1K | 7.5 | 389 | 10.4 | Light | Poor | Good |
| | Solvent | | | | | | |
| | Prime | | | | | | |
| 0.37:1 | 1K | 8.7 | 389 | 10.4 | Light | Good | Good |
| | Solvent | | | | | | |
| | Prime | | | | | | |
| 6.95:1 | 2K | 7.5 | 435 | 10.4 | Light | Good | Good |
| | Solvent | | | | | | |
| | Clearcoat | | | | | | |
| 6.95:1 | 2K | 8.2 | 435 | 10.4 | Some | Poor to | Good |
| | Solvent | | | | stick/ | Good | |
| | Clearcoat | | | | smear | | |

### Example 6

AFCS-1, AFCS-3, and AFCS-4 were subjected to the Paint Detackification Test Procedure, wherein 0.3 mL of the “1K Solvent Prime” paint was added to each test jar along with one of AFCS-1, AFCS-3, or AFCS-4 in the amounts shown in Table 6. Then an amount of Core Shell 71306, a cationic acrylamide copolymer obtained from the Nalco Water company of Naperville, Illinois as a 1 wt % dispersion in water, was added to the jar as the flocculant in the amounts shown in Table 6. No pH adjustments were made in any of the tests. In each of the tests of Table 6, a precipitate was observed to form. The tackiness of the precipitate was assessed. Additionally, observations of sludge quality, turbidity of the supernatant, and sludge quality mass are noted in Table 6. The various AFCS worked well to remove tackiness of the solvent-based paint when compared side by side.

TABLE 6
Detackifier type and flocculant amount applied to the
Paint Detackification Test in Example 6, and observed
test results regarding sludge quality, turbidity of
the supernatant, and tackiness of sludge masses.

| Detackifier, | Flocculant, | | Sludge | |
|---|---|---|---|---|
| ppm solids | ppm solids | Tackiness | Quality | Turbidity |
| AFCS-1, 373 | 10.4 | None to Light | Excellent | Good |
| AFCS-4, 379 | 8.4 | None | Good to | Excellent |
| | | | Excellent | |
| AFCS-3, 292 | 6.3 | None | Excellent | Excellent |

### Example 7

Two sodium stabilized colloidal silicas were employed as detackifiers in the Paint Detackification Test Procedure and paint detackification performance was compared to the performance of AFCS-3. The sodium stabilized colloidal silicas were not amine-functionalized. The first sodium stabilized colloidal silica, SSCS-1, had a particle size of 15 nm and surface area of 200 m²/g, and was used in the Paint Detackification Test at the as-supplied pH of 10.95, 18 wt % solids. The second sodium stabilized colloidal silica, SSCS-2, was the same as SSCS-1 except that prior to applying it to the Paint Detackification Test, the pH was adjusted to 2.47 with nitric acid, further wherein SSCS-2 was 17.6 wt % solids.

In each of the tests of Table 7, a precipitate was observed to form. Sludge tackiness, sludge quality, and supernatant turbidity testing of the resulting combinations were carried out; observations are shown in Table 7. The sodium stabilized colloidal silicas SSCS-1 and SSCS-2 performed poorly regardless of pH, in terms of sludge tackiness, sludge quality, and supernatant turbidity. However, the amine-functionalized colloidal silica AFCS-3 performed excellently, in particular providing a supernatant with extremely low turbidity, and high-quality sludge free of tackiness.

TABLE 7
Comparison of sludge quality, turbidity of the supernatant,
and tackiness of sludge masses performance of AFCS-3 with
two silica stabilized colloidal silica (SSCS) controls
in the Paint Detackification Test of Example 7.

| Detackifier, ppm | Flocculant, | | Sludge | Turbidity |
|---|---|---|---|---|
| solids | ppm | Tackiness | Quality | (NTU) |
| SSCS-2, 289 | 2.1 | Sticky | Poor | 128 |
| SSCS-1, 296 | 3.1 | Sticky | Poor | 129 |
| AFCS-3, 292 | 6.3 | None | Excellent | 10.1 |

What is claimed is:

1. An overspray treatment composition comprising a detackifier comprising an amine-functionalized colloidal silica; and a coagulant comprising a polyionic compound, an inorganic salt, or a combination thereof.

2. The overspray treatment composition of claim 1 wherein the coagulant is selected from aluminum sulfate/chloride, ferric chloride/sulfate, polyaluminum chloride, a water-soluble aluminum complex with the general formula AlₙCl₍₃ₙ₋ₘ₎(OH)ₘ; and combinations of two or more thereof.

3. The overspray treatment composition of claim 1 wherein the coagulant is Al₂Cl(OH)₅.

4. The overspray treatment composition of claim 1 wherein the amine-functionalized colloidal silica comprises about 0.1 μmol to 15.00 μmol of amine functionality per square meter of silica surface area.

5. The overspray treatment composition of claim 1 wherein the amine-functionalized colloidal silica is an amine-functionalized silica sol having a particle size between 10 nm and 100 nm.

6. The overspray treatment composition of claim 1 wherein the weight ratio of amine-functionalized colloidal silica solids to coagulant solids is about 1:10 to 20:1.

7. A treated washwater comprising a water source and 0.01 ppm to 10,000 ppm by weight of an overspray treatment composition, the water source disposed within a paint overspray waterwash system; wherein the paint overspray treatment composition comprises an amine-functionalized colloidal silica.

8. The treated washwater of claim 7 further comprising 0.01 ppm to 1000 ppm by weight of a coagulant.

9. The treated washwater of claim 7 wherein the pH of the treated washwater is between 6.5 and 10.

10. A method of treating a paint overspray, the method comprising
adding an overspray treatment composition to a washwater located within a paint booth overspray waterwash system or operably connected to a paint booth overspray waterwash system, to form a treated washwater; and
operating the paint booth overspray waterwash system while spraying a paint within the paint booth, wherein the treated washwater is contacted with a paint overspray to form a treated overspray,
wherein the overspray treatment composition comprises an amine-functionalized colloidal silica and optionally a coagulant.

11. The method of claim 10 further comprising adding a flocculant to the treated overspray to form a flocculated overspray.

12. The method of claim 11 further comprising subjecting the flocculated overspray to solid-liquid separation to obtain one or more associated complexes and an aqueous treatment residue.

13. The method of claim 12 wherein the aqueous treatment residue is subjected to one or more cycles of use within the paint booth overspray waterwash system.

14. The method of claim 10 wherein the paint is a solvent-based paint.

15. The method of claim 10 wherein the paint is a water-based paint.

16. A kit comprising
an amine-functionalized colloidal silica;
a flocculant, and
instructions that direct a user to add 0.01 ppm to 10,000 ppm by weight of the amine-functional colloidal silica to either a water source located within a paint overspray waterwash system, or a water source that is subsequently applied to a paint overspray waterwash system.

17. The kit of claim 16 further comprising a coagulant.

18. The kit of claim 17 wherein the amine-functional colloidal silica and the coagulant are provided as a mixture thereof in a ratio of 1:10 to 20:1 by weight.

19. The kit of claim 17 wherein the coagulant is aluminum chloride hydroxide and the instructions further direct the user to add the coagulant to a water source in an amount of 0.01 ppm to 1000 ppm by weight.

20. The kit of claim 16 wherein the amine-functional colloidal silica and the flocculant are provided separately, and the instructions further direct the user to add the amine-functional colloidal silica and flocculant in a ratio of 1:10 to 200:1 by weight.
